(19) United States
(12) Patent Application Publication
(10) Pub. No.: US 2002/0069102 A1
(43) Pub. Date: Jun. 6, 2002

(54) Method and system for assessing and quantifying the business value of an information techonology (IT) application or set of applications

(76) Inventors: David P. Vellante, Still River, MA (US); Edward A. Gershenson, Sudbury, MA (US); David A. Floyer, Mountain View, CA (US)

Correspondence Address: Gerald L. Smith, Mueller and Smith, LPA, Mueller- Smith Building, 7700 Rivers Edge Drive, Columbus, OH, 43235, US

(21) Appl. No.: 09/845,539

(22) Filed: Apr. 30, 2001

Related U.S. Application Data
(60) Provisional application No. 60/250,742, filed on Dec. 1, 2000.

(51) Int. Cl. G06F 17/60

(52) U.S. Cl. 705/10

(57) ABSTRACT

Method and system for assessing and quantifying the business value of an information technology application or set of applications, particularly as those application or applications are subjected to a proposed change or variation. The method includes steps wherein a base application value is derived, following which a business experience based coefficient or factor is derived and, by using that coefficient or factor, the base application value is uplifted to provide an actual application value for an application or applications. A potential business value is derived by operating on the actual application value with a value representing the perceived value of an enablement attribute construct corresponding with the noted change to be applied. The ultimately sought net business value is derived for an application by removing the operational cost of the application from the potential business value. As an adjunct to the method the actual application value may be increased by the value of the highest optimized business value of an enablement attribute construct of the application to provide upper bound maximum business value of an application for comparing the relative results of any given analysis.

### CROSS-REFERENCE TO RELATED APPLICATIONS

This application claims the benefit of U.S. Provisional Application No. 60/250,742, filed Dec. 1, 2000

### STATEMENT REGARDING FEDERALLY SPONSORED RESEARCH

Not applicable.

### BACKGROUND OF THE INVENTION

The genesis of the phenomena referred to in the business community as Information Technology (IT) is perhaps the development of the mainframe computer for the wartime task of computing shell trajectories. That vacuum tube implemented technology entered commerce during the 1950s. Usually housed in a climate controlled dedicated facility, these mainframe computers typically operated with Hollerith card implemented batch processing to evolve a computed output on magnetic tape or disk. Computer to computer connections appeared in the 1960s as part of preparation for surviving nuclear war. That communication system now is referred to as the “internet”. In effect, the internet is a multitude of networks which interconnect to transfer information but without the supervision of an oversight organization.

While personal computers were available before 1981, this was the year that IBM Corporation unveiled its PC, a product which readily was received by the business community. Over the years to follow, these desktop computers became more powerful as a multitude of software companies evolved programs and solid state hardware improved remarkably. In 1989, a physicist at the European Particle Physics Laboratory, known as CERN proposed a worldwide web (WWW), a set of protocols layered upon the internet which utilized Hypertext, a technique for presenting and relating information which uses links rather than linear sequences. The Web was demonstrated in 1991 and expanded rapidly with hypermedia and multimedia software. Developed in concert with the Web were a series of software interface programs structured to aid in navigating the Web which are called “browsers”. In this regard, a team of programmers at the national center for super conducting applications (NCSA) developed a non-proprietary graphical interface browser for the Web which was released in 1993 under the name “Mosaic”. Within six months of that release, more than two million people downloaded Mosaic from the NCSA host computer in Champaign Illinois. The Mosaic browser is a cross-platform application, such that it is able to run in various different computing environments. The potential for profit making business use of the internet commenced in the early 1990s when the National Science Foundation eliminated its support thereof. With this change, business began to use the internet, and the internet began a period of exponential growth.

This technological era also brought forth the database, a technology which includes software programs for creating and managing databases; the data itself which must be created or converted into storable form; and high capacity magnetic systems such as disk drives capable of storing enormous quantities of binary data.

A still third component of this technological era evolved information technology adding communication networks to existing components. Mainframe computers fell into disfavor to be replaced by desktop computers performing with servers within both intranet and internet systems. More recently wireless communication has joined these technologies to further expand their growth.

Information technology now permeates every aspect of a business, requiring chief executive officers (CEOs) to involve themselves in IT planning and decision making. Further, a new high level executive position, that of chief information officer (CIO) evolved in major institutions.

“In the 1990s, IT has become the fourth major resource available to executives to shape and operate an organization. Companies have managed the other three major resources for years; people, money, and machines. But today IT accounts for more than 50% of the capital-goods dollars spent in the United States. It is time to see IT for what it is: a major resource that—unlike single-purpose machines such as lathes, typewriters, and automobiles—can radically affect the structure of the organization, the way it serves customers, and the way it communicates both internally and externally.

Understanding the importance of the fourth resource and building it into theory of the business (as well as into strategies and plans) are more important today than ever for the CEO.

“The End of Delegation?” “Information Technology and the CEO”, Perspectives from the Editors, Harvard Business Review, September October 1995

The implantation and high capital investment of IT within business structures has called for a concomitant capability for evaluating its worth to an organization in consistent and understandable metrics. Traditional accounting-based technologies heretofore used by business and promoted in business schools generally fail to establish a workable gauge of the value of information technology. A wide range of these conventional methodologies have been employed to evaluate initially installed equipment and associated software. For example, one such method, referred to as “Total Cost of Ownership” (TCO) which sums all the different elements of any alternative philosophies or alternate ways of doing things has been employed. While these methods, as well as standard analyses involving return or investment (ROI) and time to breakeven were applied to initial IT procurement, they generally fail where high level changes or IT variations are contemplated. Evaluating the business impact or dynamics of additions or improvements to initially installed legacy IT systems has been an illusive goal for business analysis, posing the dilemma of at least partially hunch-base procurement decisions on management.

As we shall see, computing a monetary value for a return from IT investments is not easy. In fact, in some cases, it almost appears impossible, at least at the time the firm is making an investment.

a good example of investing in IT infrastructures; a company might invest heavily to build a network of computers; a return from that network comes in literally hundreds of ways, as individual employees use the network to do their job better and IT staff members build applications of technology that take advantage of the network infrastructure. At the time the firm decided to invest in the network, it could only guess at the nature activities the network might stimulate. A few years later, it is possible to study the return on the projects the network enabled, but is a rare company that would devote the time and resources to such post hoc analysis.

In searching for IT value, we seek all types of contributions from investments in technology. Some investments demonstrate traditional returns that can be expressed in monetary terms. Other examples demonstrate indirect returns from IT investments. Sometimes, it appears that an IT investment has prevented a negative return, for example, when a firm develops a system to keep up with a competitor and avoid losing market share. In instances where technology becomes intertwined with the strategy of the corporation, the contribution of IT seems very valuable but exceedingly difficult to value.

Lucas, Jr., H. C. “Information Technology and the Productivity Paradox”, pp 4-5, Oxford University Press, 1999.

### BRIEF SUMMARY OF THE INVENTION

The present invention is addressed to a method and system for assessing and quantifying the business value of an information technology application or set of such applications. With the assessment approach of the invention, information technology analysts or professionals may rapidly derive net business values for one or a set of these applications, particularly with respect to a proposed change or variation to the applications. By comparing and contrasting the derived net business values evoked by various alternative changes, the analyst is afforded the opportunity to more accurately devise an optimal mix of system variations and combinations to enhance the overall value of an organization specific information technology system. The system implemented method of the invention calculates the net value of information technology applications initially by deriving a base application value for each. In a practical and preferred arrangement, this is carried out by evaluating the number of active and concurrent users of an application and multiplying or adjusting this figure by the fully loaded costs of those users.

An actual application value for each such application is evolved by deriving a business experience based coefficient or factor for adjusting the base application value, this coefficient relating the relative productivity contribution represented by the application. The base application value then is uplifted to provide an actual application value. This uplifting procedure may be carried out by generating the product of the base application value with the experience based coefficient factor. A potential business value then is derived for each application by operating upon the actual application value with a value representing a perceived value of an enablement attribute construct corresponding with any change or variation, the impact of which on the information technology system will be evaluated. These enablement attribute constructs will include the value of the availability of the application with respect to the applied change or variation; the value of flexibility of the application with respect to the applied change or variation; the value of security of the application with respect to the applied change or variation; and other elected enablement attribute constructs suited to a particular information technology system.

From the potential business value for each application, then there is removed the corresponding operational cost of the associated application. This provides the ultimately desired net business value for the targeted information technology application as it is affected by a change or variation.

The above methodology may additionally be accompanied with a derivation of a maximum business value representing a perfect business world which is developed by increasing the actual application value by the value of the highest optimized business value of one or more of the noted enablement attribute constructs of the application. This affords the information technology analyst or professional an opportunity to compare the derived improvement or net application value with what may be considered the upper bound or perfect business world bound for such a variation or change.

The system implementing the method of the invention comprises one or more manual input terminal assemblies with readouts and which are controllable to provide an input field for receiving treated derivative data and an output field for conveying artful data corresponding with the attributes of the concerned information technology infrastructure. Also included are one or more data interchange assemblies which are controllable to provide an input field for receiving treated data and an output field for conveying treated attribute data corresponding with attributes of the information technology infrastructure. A memory retained model program may be provided which is controllable to respond to the artful data conveyed from the terminal assembly and to the treated attribute data from the data interchange assembly for generating model derived treated derivative data. At least one multi-cell aggregation field which is retained in memory is controllable to respond to the model derived treated derivative data, to the artful data and to the treated derivative data to provide an organization specific business value or net application value. A controller is provided with the system which is configured for carrying out control of the terminal assembly, the data interchange assembly, the model program and the control over the aggregation field.

Other objects of the invention will, in part, be obvious and will, in part, appear hereinafter. The invention, accordingly, comprises the method and system possessing the construction, combination of elements, arrangement of parts and steps which are exemplified in the following detailed description.

For a fuller understanding of the nature and object of the invention, reference should be made to the following detailed description taken in connection with the accompanying drawings.

### BRIEF DESCRIPTION OF THE DRAWINGS

FIG. 1 is a schematic block diagram illustrating the techniques for generating a maximum business value of a target application and a net business value of that application;

FIG. 2 is a schematic block diagram expanding upon the components of FIG. 1, showing the development of a potential business value and the utilization of data bases;

FIG. 3 is a schematic block diagram representing an expansion of FIG. 2 to a portfolio of applications;

FIG. 4 is a block schematic diagram illustrating the development of operational costs described in connection with FIGS. 1-3;

FIG. 5 is a block schematic diagram expanding the subject matter of FIG. 4 to include a portfolio of applications and showing the use of databases;

FIG. 6 is a block schematic diagram illustrating the generation of an effective user cost metric;

FIG. 7 is a block schematic diagram illustrating the methodology of the invention;

FIG. 8 is a schematic mathematical diagram illustrating a single layer of aggregation field hierarchy;

FIG. 9 is a schematic mathematical diagram illustrating the utilization of a single layer of aggregation field hierarchy and the utilization of databases;

FIG. 10 is a schematic mathematical diagram illustrating the utilization of two layers of aggregation field hierarchy;

FIG. 11 is a schematic mathematical diagram similar to FIG. 10 but incorporating database inputs;

FIG. 12 is a schematic mathematical diagram illustrating three layers of aggregation field hierarchy;

FIG. 13 is a schematic mathematical diagram similar to FIG. 12 but incorporating database inputs;

FIG. 14 is a schematic mathematical diagram demonstrating the development of a connectivity rating utilizing two hierarchal aggregation fields and database inputs;

FIG. 15 is a block schematic diagram showing a system according to the invention employing terminal and interchange assemblies in conjunction with an input multiplexor, shared models and buffer memories;

FIG. 16 is a block schematic diagram showing the system of FIG. 15 in combination with reference models;

FIG. 17 is a block schematic diagram showing the system of FIG. 15 and incorporating an input queue in combination with the multiplexor;

FIG. 18 is a block schematic diagram showing the system of FIG. 17 in combination with reference models;

FIG. 19 is a schematic block diagram showing the system of the invention utilizing dedicated models in combination with buffer memory but without a multiplexing function;

FIG. 20 is a schematic block diagram of the system of FIG. 19 but incorporating reference models;

FIG. 21 is a schematic block diagram of a system according to the invention showing a flow through system architecture utilizing dedicated models and no buffer memory; and

FIG. 22 is a schematic block diagram of the system of FIG. 21 with the inclusion of reference models.

### DETAILED DESCRIPTION OF THE INVENTION

In the discourse to follow, the methodology of the invention is set forth in a manner wherein a single application and then combined applications are treated to derive ultimately sought net business values for a single application, then a portfolio of applications. Next a line of business (LOB) compilation is described to provide an enterprise net business value. The discourse then turns to an aggregation mathematics structure implementing the methodology and, finally, to the system structure as implemented with hardware/software, models and database development to derive net business value metrics corresponding with any proposed system change, herein referred to as a “variation”.

The IT systems of a given organization are involved with an information technology infrastructure. These IT infrastructures are somewhat evasive to define, inasmuch as they are historically concerned with advances in the subject technology associated with hardware, software, communications, support and the like. In 1996 investigators classified responses to surveys on infrastructure into eight categories:

1. Communications Management

2. Applications Management

3. Data Management

4. Standards Management

5. Education Management

6. Services Management

7. Security

8. IT R&D

Additionally, five core infrastructure services have been identified:

1. Management of corporation wide communication network services

2. Management of group wide or firmwide messaging services

3. Recommending standards for at least one component of IT architecture (hardware, operating system data, communications, etc.)

4. Security and disaster planning and recovery

5. Technology advice and support services

The study at hand also listed eighteen other possible infrastructure services, including the actual management of firmwide applications, databases, consulting services, EDI management, and training and the like. See: “Information Technology and the Productivity Paradox” (supra) pp 98, 99.

The instant methodology primarily looks to the impact of a variation or change in one or more applications within an IT infrastructure. In the method and system, an output referred to as “net business value” is derived for each application of the system which is involved. Typically, a plurality or portfolio of these applications is evaluated to provide a sum of net business values representing the overall impact of a variation on the system. However, in combination with this overall sum reflecting the change or resultant from a variation to the system, there also is published an application net business value with respect to each of the applications of the portfolio. Thus, the investigator initially is given a sequence of outputs analogous to the outputs of multi-channel analyzers employed in the technical world. Because the net business value generally will be conveyed to the highest levels of executive management of major organizations, this net business value is represented in terms of a common currency, for example, dollars. However, the value is what may be deemed absolute money and is specific to the organization whose system is being evaluated. Thus, this net business value deriving methodology may be deemed to be an organization specific one. However, other metrics may be employed, for example, when the method and system are employed in conjunction with governmental entities including educational institutions. For each analyst, the net values derived may be measured in terms of revenues, profit contribution, productivity, market cap, budget reduction, diplomas issued, patients treated, sales calls made and the like. Accordingly, the term value or cost as employed herein typically will refer to a currency term but may refer to other metrics.

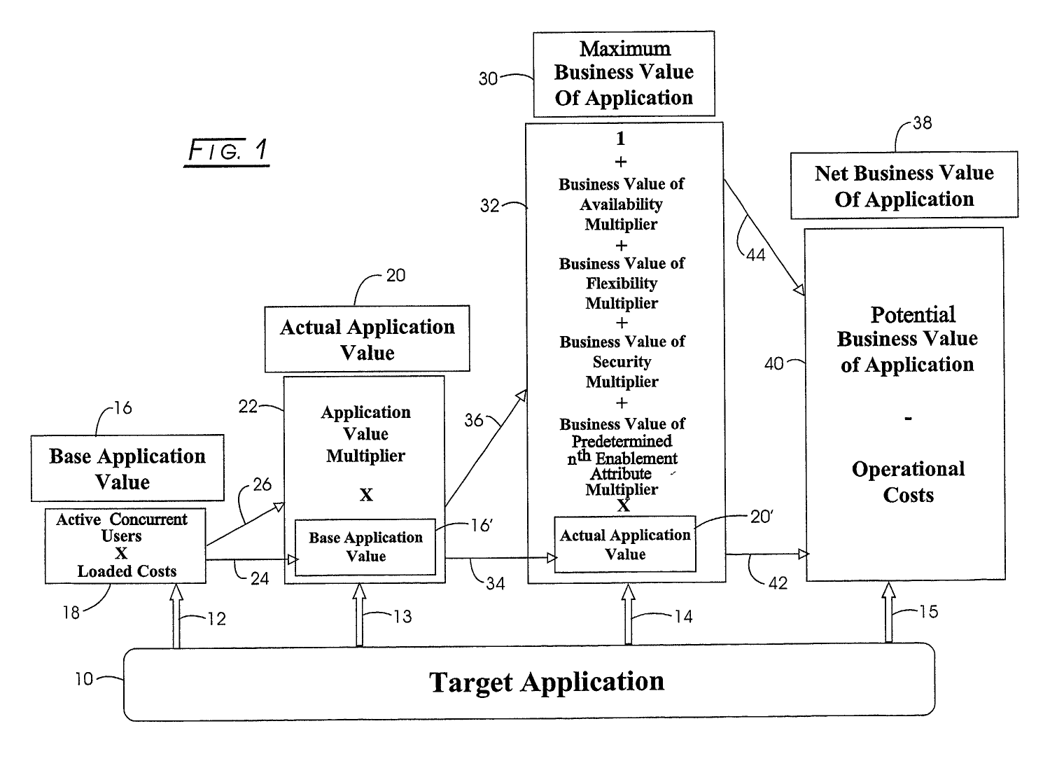

Referring to FIG. 1, a block diagrammatic representation is presented describing a broad illustration of the methodology at hand as it is concerned with a singular application within an IT system. The objective of this method is to reach a net business value of the target application. In the figure this target application is represented at block 10 and its relationship with the methodology is represented by the arrows 12-15.

The initial step in the methodology at hand is to determine a base application value or cost as represented at block 16. Inasmuch as the target application is a set of components of the infrastructure including, for example, individual programs, people using the programs, cost of the hardware and software at hand as well as the cost of support, the base application value, as represented at block 16, can be computed by conventional accounting techniques, inasmuch as it is the basic cost for operating the application before a defined variation or change to the system is made. This base application value corresponds with the cost of an application use or employment cost construct. That construct may comprise a combination of constructs such as the cost of the infrastructure corresponding with the target application; the cost of the support of the application use of that infrastructure; or the cost of active concurrent users of the application. The latter approach has been a convenient one for most of the derivations of base application values. Accordingly, this approach is represented at block 18 providing for the multiplication of the number of concurrent active users of the target application multiplied by their corresponding loaded costs. The number of concurrent active users is the number of effective users of the application over a predetermined measurement interval. For example, one working day. The terms “active concurrent” are utilized to define the utilization of the application by what may amount to a broad number of users, many of whom may generate such use for only a portion of the measurement interval. Thus the figure may represent the total number of users of the system over an interval multiplied by a percentage representing those active and concurrent over the measurement interval. The number represents equivalent or effective people. An active concurrent user is a user who is logged onto the target application and is making extensive use of the target application. Essentially, an active concurrent user represents an individual that is fully dedicated to using the target application, even if it is not the same individual. For example, a particular user of an application may only spend 10% of his or her day using the application. Ten individuals spending 10% of their time during a given day who are actively using an application or set of application represent one active concurrent user. Block 18 reveals that the number of concurrent active users is multiplied by the loaded costs associated with such users. Those loaded costs include the full cost for each one of these concurrent active users and will include the corresponding costs of salary, taxes, medical support and retirement as well as the corresponding cost for maintaining the target application components of the system, again as related to each concurrent active user. This approach has been the most often employed for deriving the base application value, inasmuch, as, for many uses of the method, hardware costs are somewhat relatively insignificant.

In accordance with the methodology of the invention, the base application value 16 is a cost dependent value which, for the target application at hand typically will be lower in value than what the target application related net business value will turn out to be. Thus, this base application value 16, before the application of variation or change to the system, is converted to an “actual application value” as represented at block 20. This actual application value 20 is arrived at by deriving a business experience based coefficient or factor, depending upon the mathematical operation elected to be performed, for the cost construct represented by base application value 16. This coefficient or factor illustrated as an “application value multiplier” generally represents the relative productivity contribution represented by the application employment cost construct or base application value 16. Accordingly, as represented at block 22 and arrow 24, the base application value, now represented at sub-block 16′, is recovered, and as represented at arrow 26, is multiplied by the application value multiplier. This multiplier is derived from a set of experiences of similar target applications in other organizations or companies as well as with the organizations represented by the target application. While the coefficient or facter can be derived by looking at the relative generation of revenues for the base application value, it can also consider profit contributions, productivity, market cap, budget reduction or other output variables such as diplomas issued, patients treated, sales calls made and the like. The factor exhibits strong dependence on the current state of information technology in the enterprise, as well as on user-specific sets of skills in applying and managing IT tools. In this regard, the same level of actual application value can be created with non-automated or low-automation labor which likely will be complimented by prohibitably high labor cost. For example, a very high worker count (number of active concurrent users) at somewhat low cost (loaded cost) can be translated into a corresponding high base application value resulting in a very low or less than one value range for the application value multiplier or factor.

As a simple example, consider a company having one hundred users or employees who are paid at an amount of $50,000.00 per year each, and all contribute full time to a singular target application. The cost of the application per year is $5,000,000. Where these one hundred people or users generate $25,000,000 worth of revenue per year, then the revenue per person or user is $250,000.00. Associating the $5,000,000 in cost with the generated $25,000,000 in revenue, an application value multiplier may be considered to be five. In practice, the people or users for this example actually are active concurrent users. The application value multiplier or factor typically falls within a range of from about two to about twenty. As apparent, the application value multiplier exhibits a strong dependence on the current state of the information technology associated with the target application and is a business experience-based factor. Applying the application value multiplier to the base application value generally functions to uplift that latter value and in general is evolved by generating the product of the value of the cost corresponding with the application employment cost construct and a business experience based coefficient.

This uplift of the base application value to the actual application value is a function of the revenue or productivity generated by the concurrent active users of the target application. Such uplifted value will be some percentage of a company's or organization's revenue. The actual application value per active concurrent user should roughly approximate revenue per employee of the company or organization with some adjustments made based on the value of the specific user. For example, an active concurrent user that represents a sales person will have a greater value than a mail clerk. Moreover, the revenue generated by the sales person likely will be greater than the average revenue per employee for the company and the mail clerk less than the company average.

The actual application value will be constrained by the effect of the technologies which are associated with it. A given computer driven infrastructure has various technology characteristics or enablement attributes which generally will impose a constraint when considering the development of a net business value of an application. Three of these enablement attributes have been identified as being of considerable importance to the instant method and others will evolve, particularly, as advances in technology occur. The association of the target application 10 with the computation at block 22 is represented at arrow 13.

Assuming now that the variation or change to the system is made, these enablement attributes are evaluated. As a highly important but not mandated component of this evaluation, as represented at block 30, a “maximum business value of application” may be computed. This is an optimized valuation wherein the enablement attributes are considered to be non-constraining and, as it were, representative of a perfect business world. Thus, the actual application value for this maximum business value of application 30 is increased by the value of the highest optimized business value of one or more predetermined enablement attribute constructs for the application. Each enablement attribute is a three-dimensional construct. For the instant demonstration, they are provided as a multiplier or coefficient applied to the actual application value, however, a summing procedure also may be employed. Because of the highest optimized criteria applied with these constructs, the business value of application 30 represents an upper bound for the target application net business value. This gives the analyst an opportunity to comparatively evaluate the organization specific net business value of the target application against what will be an optimum valuation which could only be accomplished in a perfect business world.

The maximum business value of the target application 30 may be derived as represented at block 32 for this procedure. Looking to that block, the actual application value 20 is employed as represented at arrow 34 and operated upon, as represented at arrow 36. In this regard, note that the actual application value represented at block 20 now is present within block 32 as represented at 20′.

At the present time, three application enablement attributes have been isolated as being of very high importance in developing both a business value of application 30 as well as a net business application. The first of these is “application availability”, a construct which basically recognizes that computers will fail or go down. This results in planned and unplanned down time and loss of service levels in terms of on-line response time, batch elapsed time and total elapsed time for an application suite. As is apparent, a 100% application availability represents a perfect system or machine. Stated otherwise, that perfect system or machine would represent zero unavailability. Derived as a multiplier as represented at block 32, that multiplier is added to the unit, 1 for an ultimate derivation of maximum business value of application 30 as a product with the actual application value 20′.

The next of the important three enablement attributes is “flexibility”, representing the ability of the system to change. In the information technology sphere, change historically has been quite profound. Thus, the flexibility attribute is a measure of the ability to change the application to meet new business challenges, i.e., variations for the time-to-market for a new functionality. Measurement is made with this construct by the increased speed of developing and deploying changes to an existing application or the increase in speed of application development in deployment of such applications. Considered in this flexibility there is the concept of “latency” and the cost of such latency as delays in implementation of a variation or change are contemplated and estimated.

Thus this enablement attribute construct for the target application is the value of perfect flexibility of the application which, in a perfect business world, subsumes the variation or change in the system with a zero latency. At block 32, the enablement attribute for flexibility is provided as a multiplier identified as “business value of flexibility multiplier” which is added with the business value of availability multiplier to the unit, 1.

A third enablement attribute isolated is that of “security” or operational security. This construct looks to a loss of intellectual property, software losses occasioned by viruses and the like, catastrophic occurrences requiring disaster recovery (DR) and the like. Employed in developing the optimized business value of application 30, the security construct is considered in conjunction with a perfect business world, the construct evolving the value of perfect security of the target application when it has subsumed the variation or change now being evaluated. This enablement attribute is represented in block 32 as a coefficient identified as: “Business Value of Security Multiplier”. That attribute multiplier is added with the flexibility multiplier and availability multiplier to the unit, 1.

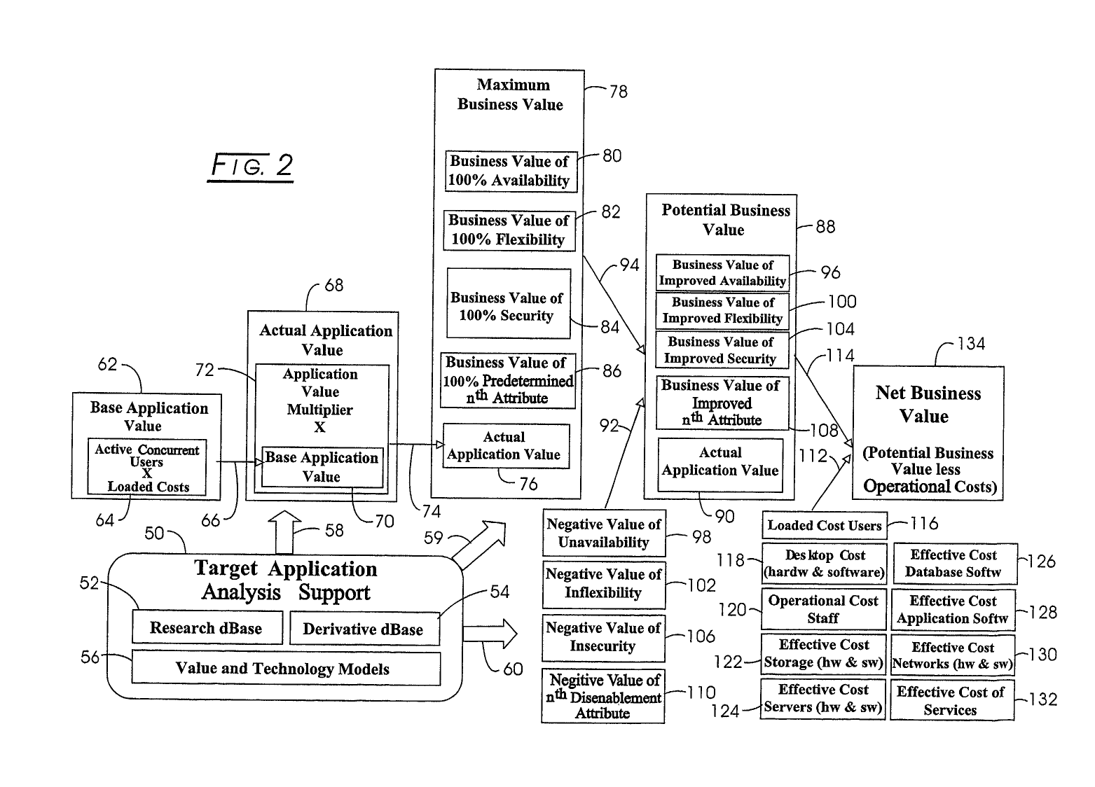

Other enablement attributes will evolve and have been heretofore considered to be of lesser importance. However, as information technology infrastructures expand in terms of size, value and enhanced technology, it is quite apparent that additional enablement attributes will be employed in evolving the maximum business value of application 30. These adjunct enablement attributes are represented in FIG. 2 as multipliers and are identified as: “Business Value of Predetermined n^{th} Enablement Attribute Multiplier”. They are added with the security multiplier, the flexibility multiplier, and the availability multiplier to the unit, 1, for evolving a product with the actual application value 20′. The association of the target application 10 with the computation at block 32 of this business value of application 30 is represented at arrow 14.

Target application association with the derivation of the net business value thereof is represented at arrow 15 and that net business value of the target application is represented at block 38. The derivation of a net business value of the application as at 38 utilizes the earlier-described enablement attributes but as a real business world derivation. Their function in adjusting the actual application value as at 20 is represented as a “potential business value of application”. From that potential business value of application there is subtracted “operational costs”, as represented at block 40, to evolve the ultimately sought net business value of the application 38. Where maximum business value of application 30 is developed, then as represented at arrows 42 and 44 a potential business value of application may be derived by diminishing the enablement attributes to correspond with a perceived or realistic business value enablement attribute construct to develop the potential business value of application shown in block 40. However, the attribute perceived values may be directly derived for the operations represented at block 40 where the maximum business value of application 30 is not previously produced.

Looking in particular to the operational costs identified at block 40, these costs will include the loaded costs associated with active concurrent users as described in conjunction with block 18; desktop cost which is associated with hardware and software; operational cost for staff as modified by a staff utilization coefficient; the effective cost of storage as modified by a storage utilization coefficient; the effective cost of servers as adjusted by a server utilization coefficient; the effective cost of networks as modified by a network utilization coefficient; the effective cost of application software; the effective cost of database software; and the effective cost of services maintaining or supporting these components.

The effective costs identified above reflect upon a variety of usage patterns and technology influences thus characterizing the “true” cost of server and storage contributions to service levels and availability. The effective cost of storage, which includes storage networks and switching, exhibits strong dependence on various networking, storage and server architectural implementations. Thus, in addition to a storage cost increase on the basis of a “static” storage utilization ratio, this effective cost storage can be affected by the cost of meeting performance targets, replacing disk space and servers if dictated by application consideration (in network attached storage (NAS) architecture, for example) by the complexity of maintaining synchronous up-to-date copies of the same files, and by the cost of managing fragmented file systems (one file system per individual server in storage area networks (SAN), for instance). The effective cost of servers includes system network costs and can be affected by the consumption of CPU cycles for network data movement, by the consumption of network bandwidth and by the need to maintain acceptable user latency in light of the high transaction overhead of networked client-server interactions. This effective server cost also can be impacted by the percentage of network bandwidth consumed by data copying or backup, and by likely reduction in server transaction capabilities due to extensive queuing and high locking rates associated with network data movement. Consequently, more powerful servers or higher numbers of servers would be configured to compensate for the latter, thus increasing total cost.

The effective cost of staff is developed by assessing staff cost and requires establishing a full-time equivalent (fte) employee count and fully loaded costs and the percentage of time employees spend on various tasks managing an application.

Concerning the coefficients listed above, the staff utilization coefficient is a functional construct the value of which depends upon a user-specific initial value which is either uplifted or downlifted via modeled impacts of various influences or variations, such as business organization, business practice, application portfolio and the corresponding information technology infrastructure.

The storage utilization coefficient similarly is a functional construct the value of which depends upon a user-specific initial value which is either uplifted or downlifted via model impacts of various influences, i.e. variations, such as information technology organization, application and workload type and intensity, a specific operating system environment and server/storage technologies and the like.

Referring to FIG. 2, an expanded rendition of the methodology represented in FIG. 1 is set forth. Of particular interest in this figure, a target application analysis support function is represented at block 50. In carrying out the computations involved with the methodology, access is made to a research database represented at sub-block 52. This research database is one which contains the somewhat raw data gleaned from the development of net business values for other organizations and, particularly, such organizations as have a similar IT infrastructure or lines of business. The data represented at sub-block 52 further is developed with research techniques involving a processing of the research database 52, development of statistical models and the like. Such a database is shown at sub-block 54 representing a derivative database. Finally, the application analysis support 50 includes value and technology models as represented at sub-block 56. In this regard, the value models are those providing multipliers or coefficients as above-described, while the technology models look to the entire information technology infrastructure, inventories and the like. The analysis support provided from sub-blocks 52, 54 and 56 are associated with the methodology as represented by arrows 58-60.

Now looking to the methodology, as in the case of FIG. 1, a base application value is generated as represented at block 62. That base application value is derived as a multiplication of the number of active concurrent users times their loaded costs. This operation is represented at sub-block 64. Next, as represented by arrow 66 and block 68 the actual application value is computed by the multiplication of the base application value represented at sub-block 70 times an application value multiplier as represented at sub-block 72. The latter multiplier has been described in connection with block 22 above. A resultant actual application value then may be employed, as represented by arrow 74 and sub-block 76, to derive a maximum business value represented at block 78. As before, this maximum business value 78 represents a perfect business world wherein the business value is not constrained by the attributes of availability, flexibility, security or other predetermined attributes. Accordingly, this upper bound of business value is shown by sub-block 80 to incorporate a business value of 100% availability; a business value of 100% flexibility as represented at sub-block 82; a business value of 100% security as represented at sub-block 84; and a business value of a 100% predetermined nth attribute as represented at sub-block 86. Unlike block 32 shown in FIG. 1, these attributes as at 80, 82, 84 and 86 are not shown as multipliers, inasmuch as the maximum business value 78 may be derived by summation techniques in addition to multiplication techniques.

Realistic or perceived values for the enablement attributes then are employed to develop a potential business value represented at block 88. As in the case of developing the maximum business value 78, the actual application value again is operated upon as represented by sub-block 90. Such operation may be either be a summation or multiplication or operational technique. For the instant demonstration, the enablement attribute entities are operated upon by applying negative values to the enablement attributes of block 78 as represented by respective arrows 92 and 94. Accordingly, a business value of improved availability, as is represented at sub-block 96, is generated by diminishing the business value of 100% availability at block 80 by a negative value of unavailability represented at block 98. A business value of improved flexibility, as represented at sub-block 100, is generated by modifying the business value of 100% flexibility represented at block 82 by a negative value of inflexibility as represented at block 102. A business value of improved security, as represented at sub-block 104, is developed by combining the business value of 100% flexibility represented at sub-block 82 with a negative value of insecurity represented at block 106. Finally, a business value of an improved nth attribute as represented at sub-block 108 is derived by summationally acting upon the business value of 100% predetermined attribute represented at sub-block 86 with a corresponding negative value of an nth disenablement attribute represented at block 110.

As the final step in the procedure as represented at respective arrows 112 and 114, operational costs are subtracted from the potential business value 88. As discussed above, the operational costs represent the sum of the loaded costs for active concurrent users (loaded cost users) as represented at block 116; desktop costs including hardware and software as represented at block 118; the operational cost of the staff as represented at block 120; the effective cost of storage including both hardware and software as represented at block 122; the effective cost of servers including both hardware and software as represented at block 124; the effective cost of database software as represented at block 126; the effective cost of application software as represented at block 128; the effective cost of networks including both hardware and software as represented at block 130; and the effective cost of services maintaining the application as represented at block 132. A result of the foregoing subtraction then provides a net business value as represented at block 134. As noted earlier herein, with the exception of loaded user cost and desktop cost as represented at blocks 116 and 118, referred to as “line of business costs” staff, storage, server and network related costs are developed in conjunction with utilization coefficients. Thus, they reflect the extent of use as contribution of those components to cost with respect to a specific application.

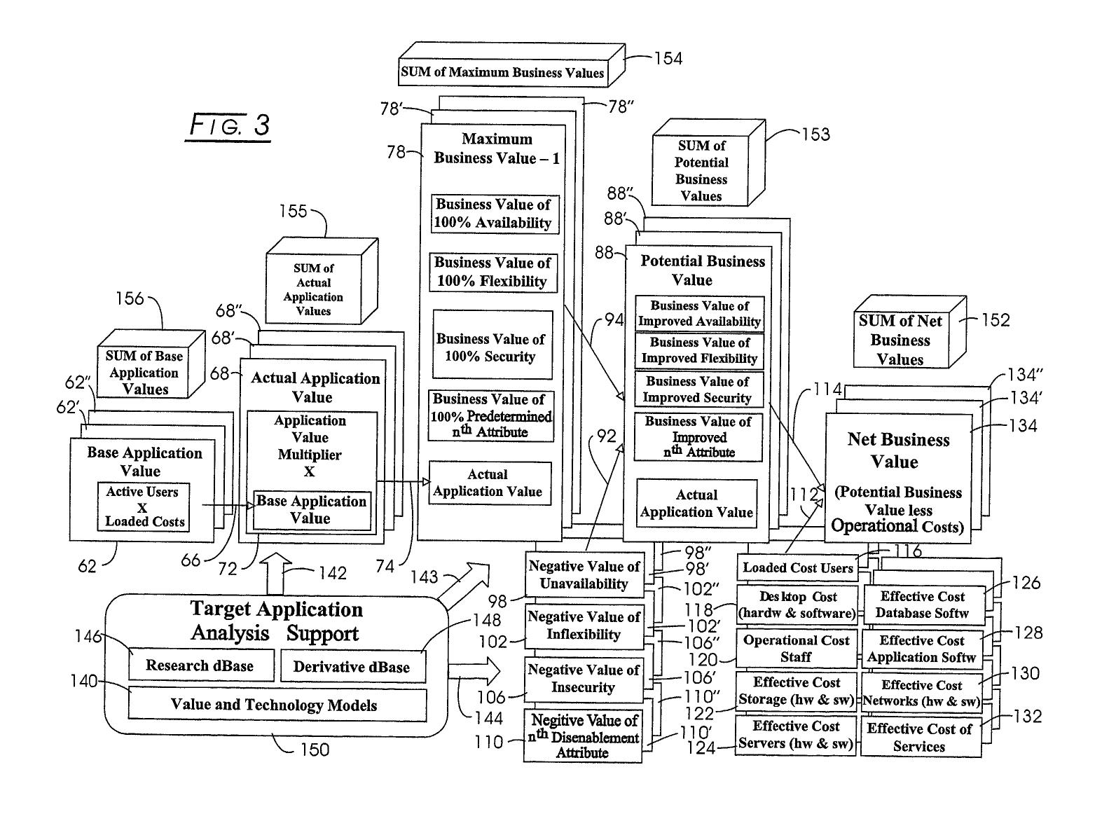

Generally, a portfolio, suite or set of information technology applications are evaluated for a given organization. The constructs leading to and including net business value then can be summed and those summations contribute in the assessment of the reaction of the applications to an applied variation or change. Thus management may observe both the summation of the individual metrics involved in the valuation or assessment and the impact of a given variation on individual applications within the portfolio. FIG. 3 illustrates this arrangement. Looking to that figure, a target application portfolio analysis support is utilized as represented at block 140 and arrows 142-144 as with the case of block 50 described in connection with FIG. 2. Block 140 includes a research database represented at sub-block 146; a derivative database represented at sub-block 148; and value and technology models represented at sub-block 150. In the figure, the steps of the methodology as applied to individual applications are identified with the same numeration shown in FIG. 2 but in primed and double primed fashion to indicate, for example, the treatment of a portfolio or set of three applications. In this regard, note that the base application value is represented at blocks 62, 62′ and 62″. The actual application value for the three applications are represented at 68, 68′ and 68″. Maximum business value for the three applications is represented at 78, 78′ and 78″. Negative value of unavailability for the three applications is shown at 98, 98′ and 98″. Negative value of inflexibility is shown at 102, 102′ and 102″. Negative value of insecurity is shown at 106, 106′ and 106″; and negative value nth disenablement attribute is shown at 110, 110′ and 110″. As before, these negative values are summationally employed in conjunction with the maximum business value to derive potential business value metrics for the three applications as represented at 88, 88′ and 88″.

The net business value again is represented at 134 and for the two additional applications is shown 134′ and 134″. Operational costs occur similarly for the three applications. However, in the interest of clarity the components thereof are shown with their original numeration only as associated with the initial (non-primed) application.

The aggregate sums of each of the components of the methodology are quite valuable in assessing the value of information technology and may be used to develop any of a variety of useful metrics for assessing the quality of the information technology as it is subject to a variation or change. In this regard, the sum of the net business values for the three applications at hand is represented at box 152. A sum of potential business values is represented at box 153. The sum of the maximum business values for the three applications is represented at box 154; the sum of actual application values is represented at box 155; and the sum of base application values is represented at box 156.

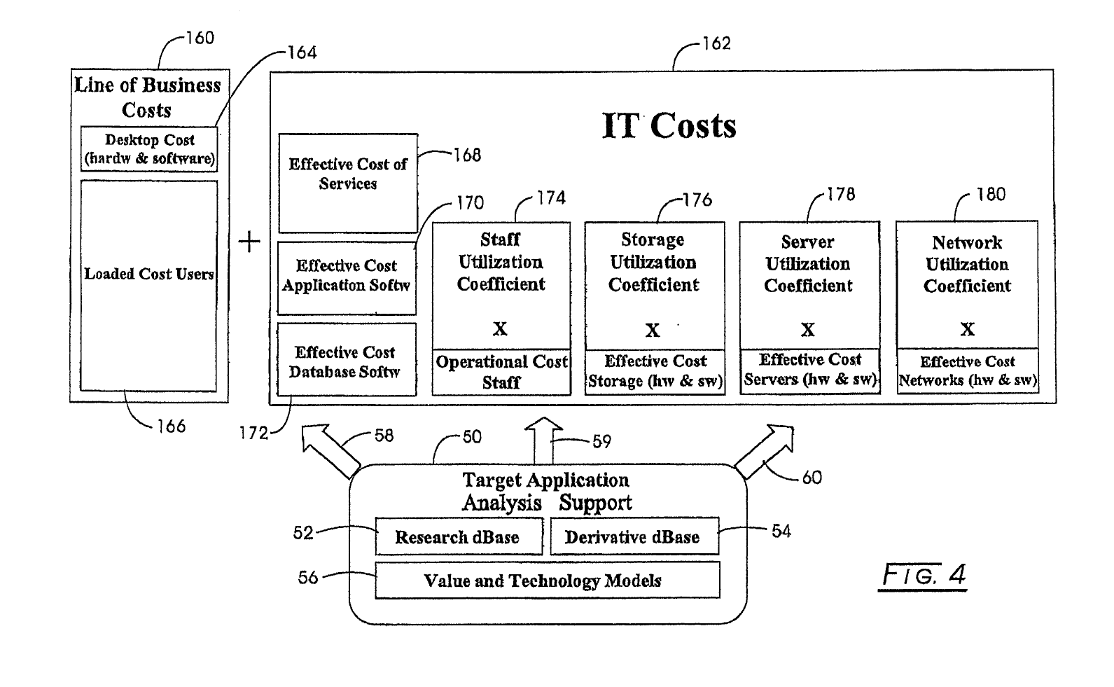

Referring to FIG. 4, a block diagrammatic representation of the technique for deriving operational cost as discussed in connection with blocks 40 and 134 above is set forth. In the figure, operational costs are shown to be the sum of line of business costs represented at block 160 and information technology (IT) costs represented at block 162. In developing these costs, as before, a target application analysis support function is employed as earlier-described at block 50. Accordingly, block 50 is reproduced in the instant figure to indicate this support. For each cost analysis for each application, the databases as represented at sub-blocks 52 and 54 as well as the models represented at sub-block 56 are enhanced and with continuing use grow more and more valuable to the IT value analyst.

The figure further reveals that the line of business costs comprise a desktop cost involving both hardware and software as represented at sub-block 164 and the loaded cost for active concurrent users as represented at sub-block 166.

Information technology (IT) costs at block 162 are seen to comprise three effective costs, to wit the effective cost of services, represented at sub-block 168; the effective cost of application software, as represented at sub-block 170; and the effective cost of database software, as represented at sub-block 172. The staff cost pertinent to the target application is derived as represented at sub-block 174 by multiplying the operational cost of the staff by a staff utilization coefficient. Storage cost is developed as represented at block 176 by multiplying the effective cost of storage for both hardware and software by a storage utilization coefficient pertinent to the target application at hand. Server costs are developed, as represented at block 178, by multiplying the effective cost for servers including both hardware and software by a server utilization coefficient pertinent to the target application. Finally, the cost of networking is developed, as represented at sub-block 180 by multiplying the effective cost of the networks including both hardware and software by a network utilization coefficient pertinent to the target application. These coefficients, in effect, represent the percentage of a given cost which is applicable to the target application.

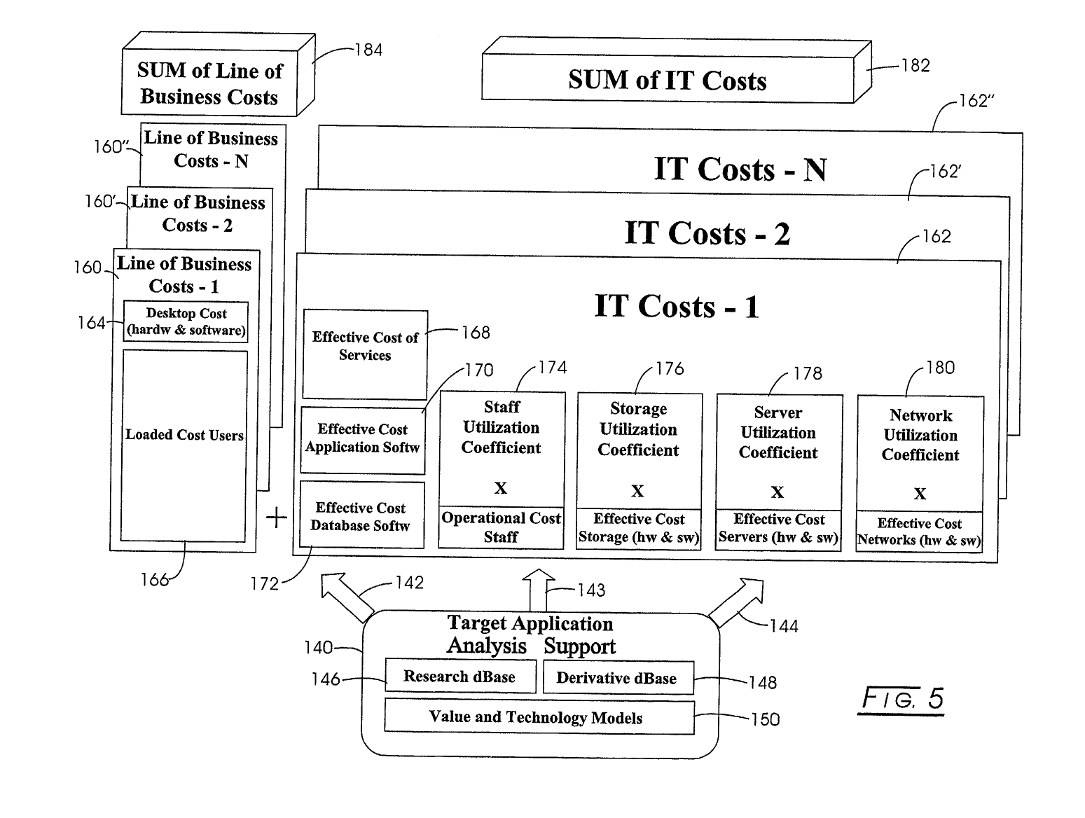

Operational cost and its subset, line of business costs and IT costs, initially can be considered with respect to a portfolio or set of applications. In this regard, the summation of those subset costs for a plurality of applications can provide a valuable metric to the IT analyst. In FIG. 5, such a summation is presented in fashion somewhat similar to that summation arrangement described in connection with FIG. 3. Carried from the latter figure is the target application portfolio and analysis support 140, again providing research and derivative database functions, as well as value and technology model functions. These functions are given the same numerical identification as shown in FIG. 3. In the figure, the identifying numeration set forth in FIG. 4 again is utilized in conjunction with three application representations identified as numbers 1 through N. In this regard, the IT Costs represented at 1-N are shown respectively at blocks 162, 162′ and 162″. Correspondingly, the line of business costs 1-N are shown at respective blocks 160, 160′ and 160″.

Metrics which will be found quite useful to the IT analyst may be provided as the sum of the IT Costs as well as the sum of the Line Of Business Costs. The former sum is represented at box 182 and the latter at box 184.

In correspondence with the above-dissertation, a sequence of equations can be produced as follows:

(1) Base Application Value=Number of Active Concurrent Users X Fully Loaded Costs

(2) Actual Application Value=Base Application Value X Application Value Multiplier

(3) Potential Business Value of Application=Actual Application Value+Business Value of Improved Application Availability+Business Value of Improved Flexibility+Business Value of Improved Security

(4) Potential Business Value of Application=Actual Application Value X (1+Business Value of Availability Multiplier+Business Value of Flexibility Multiplier+Business Value of Security Multiplier)

(5) Net Business Value=Potential Business Value of Application−Operational Cost.

(6) Operational Costs=Loaded Cost Users+Desktop Cost (hardware & software)+(Operational Cost Staff X Staff Utilization Coefficient)+(Effective Cost Storage X Storage Utilization Coefficient)+(Effective Cost Servers X Server Utilization Coefficient)+(Effective Cost Networks X Network Utilization Coefficient)+Effective Cost Application Software+Effective Cost Database Software+Effective Cost Services

(7) Net Business Value of Application Portfolio=Business Value of Application Portfolio−Operational Cost per Application Portfolio

(8) Net Business Value of Enterprise=Business Value of Application Portfolio (for line of business No. 1)−Operational Cost per Application Portfolio for a First Line of Business (LOB 1)−Operational Cost per Application Portfolio (LOB 1)+Business Value of Application Portfolio for a Second Line of Business (LOB 2)−Operational Cost per Application Portfolio (LOB 2)+. . . +Business Value of Application Portfolio for an nth Line of Business (LOB N)−Operational Cost per Application Portfolio (LOB N)

Enterprise systems present a new model of corporate computing. They allow companies to replace their existing information system, which are often incompatible with one another, with a single integrated system.

Enterprise systems appear to be a dream come true. These commercial software packages promise the seamless integration of all the information flowing through a company—financial and accounting information, human resource information, supply chain information, customer information. For managers who have struggled, at great expense and with great frustration, with incompatible information systems and inconsistent operating practices, the promise of an off-the-shelf solution to the problem of business integration is enticing.

Harvard Business Review July-August 1998, reprint 98401

A utilization of the above-value components for individual application as well as portfolios or sets of applications provide the IT analyst with a variety of information components permitting the calculation of risk assessment, application growth, quality and, importantly, resource consumption. The assessment given the analyst provides business value contributions or inputs in the noted absolute currency amounts which are organization specific. Individual components may be assessed as they relate within a portfolio of applications. Such methodology permits a development of resource breakdowns concerning the operation and development and important resource allocations for all applications within a given portfolio of them. The information collected provides a resource consumption (payroll, operational equipment, disaster recovery (DR), management, administration, loaded cost) for each application as well as for the total portfolio. By applying a variation or change to the models, resource alignment or misalignment between operational and development activities can be observed, as well as derivative correlations between consumption of resources and their respective application values. Further, resource realignment impact on computed business values of the application and the total business value for portfolio (D-Skewing Application Portfolio) are available. Then optimization derivatives may be achieved determining which application of the portfolio will bring a best value return. Finally, the methodology may be used to evaluate a rate of growth of each application in a portfolio including an observation of the current state of contribution of the application to a total organization value as well as a projected state of contribution based upon the corresponding rate of growth.

The information developed in determining the net business value of an application or portfolio of applications also can be utilized to derive any of a variety of metrics useful to the IT analyst. Another metric useful to the IT analyst is a metric referred to as “Quality of Application Portfolio”. This metric is measured as the ratio of the aggregate or sum of the business value of the application portfolio as represented at box 152 in FIG. 3 to the sum of the base application values of the portfolio as represented at box 156 in that figure. Essentially, the value of the quality of application portfolio will correspond to the per-application portfolio aggregation value multiplier (sub-block 72). The value of the quality of application portfolio (QAP) can be compared against industry-leading values of QAP in similar or complementary industries to aid the IT analyst. This metric may be expressed as the following equation:

(9) QAP=Aggregate Net Business Value/SUM (Base Application Value 1, Base Application Value 2, Base Application Value 3, . . . , Base Application Value N).

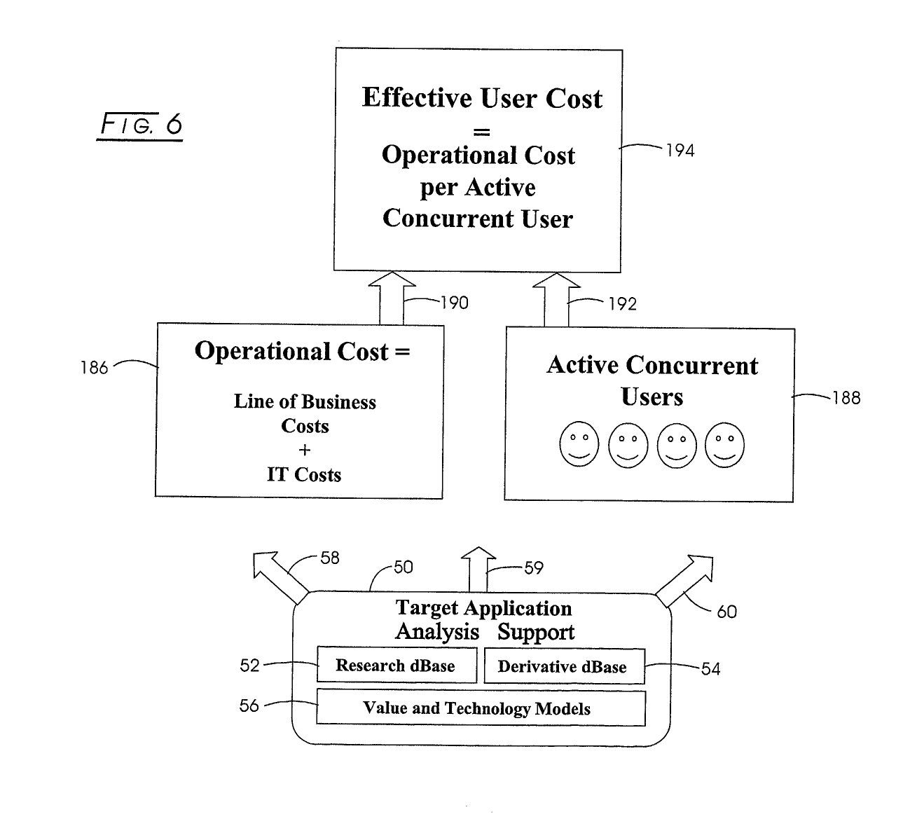

Another metric useful to the IT analyst derivable from the instant methodology is referred to as “effective user cost”. Looking to FIG. 6, a block diagram of the derivation of this metric is presented. In the figure, the target application analysis support block earlier described at 50 is re-presented, an indication that the databases and models are both upgraded and utilized in determining this metric. The effective user cost is derived from the earlier-described operational cost representing the sum of the line of business costs and IT costs as shown at block 186 and the number of active concurrent users as represented at block 188. Then, as represented at arrows 190 and 192 and block 194 effective user cost is derived by dividing the operational cost by the number of active concurrent users.

Carrying out a net business value assessment can be accomplished with a variety of different business measurements such as revenue, market capitalization budget and the like. This common term can lead to what may be deemed a “portfolio of business success measurement”. This feature utilizes an aggregated business value representing the weighted sum of net business values (NBV) derived from these different business measurements. Typically, the net business values for these different business measurement approaches will be weighted with coefficients such that the aggregated business value representing such business success measurement can be expressed as follows:

(10.) ABV total=Sum (coef 1* NBV revenue, coef 2 * NBV capitalization, coef 3* NBV budget)

In utilizing the methodology of the invention, IT analysts are urged to carry out a risk assessment of the application portfolio. Such risk assessment will look to the extent of reliance on a proprietary server technology; application database software multi-sourcing and single sourcing; software aging; maintenance and upgrade needs; security in terms of violation of intellectual property; security in terms of violation of functionality; security in terms of the adherence of personnel to security regulations and practices. The risk assessment is important inasmuch as many of the above can result in significant or even catastrophic loss of the business value of an application or application set.

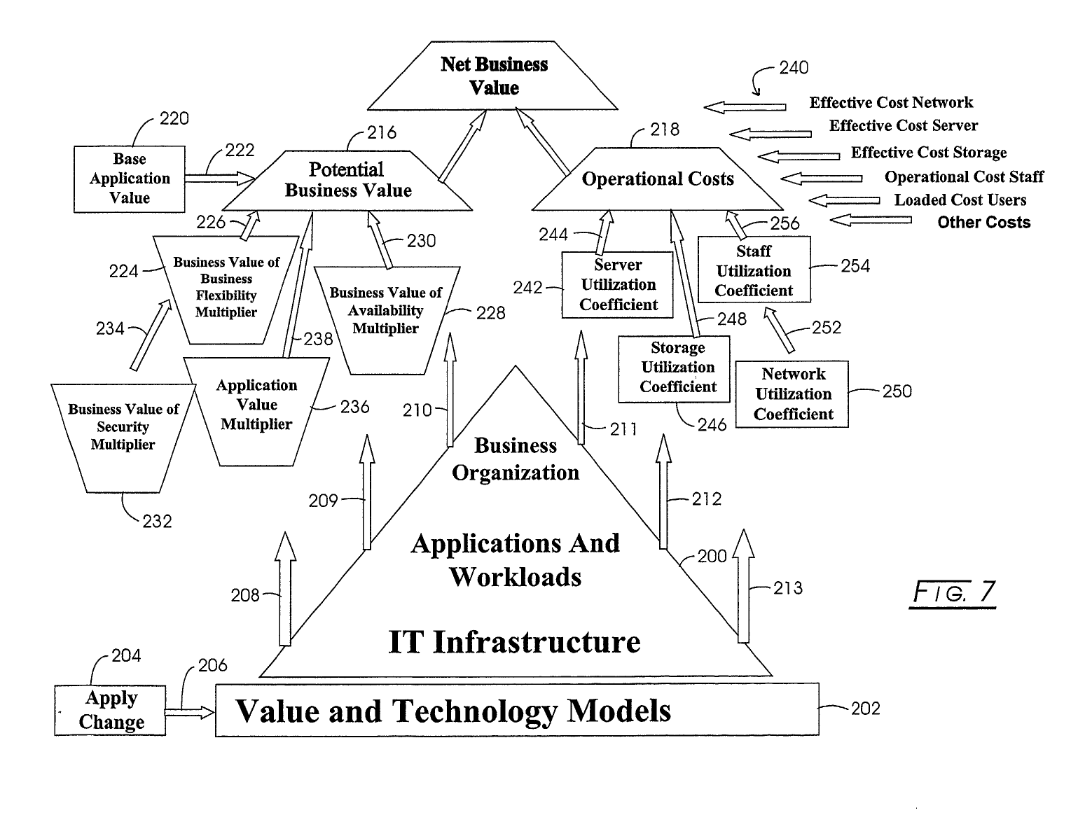

Referring to FIG. 7, a model topology is illustrated. In the figure, a centrally disposed triangle 200 is provided to represent the business organization under analysis as it exist in the real business world. That organization will incorporate applications and workloads interacting within a singular application or from application to application. And such applications will be incorporated within a then existing information technology (IT) infrastructure. The instant methodology employs the earlier-described value and technology models as represented at block 202 and, utilizing these models it then is desirable to observe the impact of a variation or change to the applications and workloads of the systems as represented at block 204. This business organization specific data change then, as represented by arrow grouping 208-213 will, in most cases alter potential business value as represented at symbol 216 and operational costs as represented at symbol 218. In this regard, it may be recalled that the potential business value is evolved with consideration of a base application value as represented at block 220 and arrow 222; the perceived value of a business flexibility multiplier as represented at symbol 224 and arrow 226; the perceived value of an availability multiplier as represented at symbol 228 and arrow 230; the perceived value of a security multiplier as represented at symbol 232 and arrow 234 and the perceived value of any other application value multiplier as represented at symbol 236 and arrow 238.

The operational costs at symbol 218 are impacted by the earlier-described effective network cost, effective server cost; effective storage cost; the operational staff cost; the loaded costs of active concurrent users; and other costs, for example, desktop costs, effective costs of services, effective costs of application software and effective cost of database software. These inputs to the operational costs are represented by arrow array 240. As described in connection with FIG. 4, four of these costs are associated with a utilization coefficient. In this regard, a server utilization coefficient input is represented at block 242 and arrow 244; a storage utilization coefficient is represented at block 246 and arrow 248; a network utilization coefficient is represented at block 250 and arrow 252; and a staff utilization coefficient is represented at block 254 and arrow 256.

Now turning to the earlier-noted aggregation mathematics structure implementing the instant methodology, in the discourse to follow, subheadings are employed to categorize and differentiate the terminology utilized.

### Work Load Definition

Work load definition is the art of mapping an application or set of applications to a specific pattern of computer resource usage and resource consumption. A workload typically will correspond to a single application or multiple applications and can be broken down into various components that define the types of the engaged-by-the-application computer resources, consumptions, specific patterns and intensities of their usage.

### Composite Work Loads

Composite work loads or work load mix corresponds to a percentage split between multiple contributing applications. The term is defined as an aggregation of multiple workloads of one-to-one correspondence with individual applications in the application portfolio. The term also can be defined as an aggregation of multiple “component” workloads, such as online transaction processing (OLTP), decision support software (DSS) internet service providers (ISP) and the like. The aggregation then constitutes a newly formed “composite” workload (NT Mix, Unix Mix and the like).

### Workload Aggregation

Workload Aggregation assesses the impact of running a workload mix upon various aspects of determining application values, application value multipliers and technology specifics. Different workload types typically correlate with different IT systematic/architectural implementations, and thus exhibit correspondingly varying impacts on value model underlying characteristics, such as service level, availability and business flexibility. Operationally, a workload mix aggregation requires a compiling of the results of multiple independent value/technology model runs, where each run corresponds to a component workload of the mix. The assessment approach used may range from a simple mathematical summation (for example, resources consumed) to weighted summation based on the percentage split of the resources utilized by the contributing applications (for example, some performance calculations) or to more complex aggregation methods.

In complex aggregation scenarios, the methodology is affected by the various operational or architectural considerations, such as the workload mix being run on a single server or on multiple servers, or corresponding applications being concurrent or sequential, or whether storage is directly attached or networked and the like.

### Initialization and Operation of the Models

Total revenue or other business measured data points may be used for setting up corresponding “initial” values of all multipliers and coefficients included in the mathematical expressions pertaining to value and technology contributions, i.e., to initialize value models and corresponding technology models. Where such total revenue is employed, then it may or not be adjusted depending upon whether it applies to an application or application portfolio. Where the allocation to the application or application portfolio must be determined from total company organization revenues, then those total revenues are adjusted by a coefficient, Krev, where Krev is greater than or equal to 1. After initialization of the models, various IT changes, i.e., variations may be introduced that will project those changes into uplifted or down-lifted states of effective costs, of business values, revenues or net business values, or profits. Such factors are discussed, for example, in connection with FIGS. 2 and 3. Further, various input constructs may be altered in line with future projections and “what if”, target attainment or optimization objectives and applied to the model types being discussed herein. A variety of application and workload variations scenarios also may be aggregated and subsequently applied to the models.

### Customization of the Models

Customization or calibration of the models is performed to reflect a company or organization-specific environment's artful constructs and to identify coefficients and multipliers for various scenarios involving imposed variations or change. The terms “artful constructs” refers to constructs which are organization specific, as opposed to being derivative or mathematically evolved in relative immunity from a given organization. However, the customization of the models also provides for the correlating of such artful constructs and coefficient multiplier values with industry-typical and industry leading experiences, capturing a multiplicity of data points related to the application. In this regard, the above-discussed research database and derivative database approaches are considered.

### Model Inputs, Outputs and Intermediates

(a) Immediate Input Values

Immediate input values will include application-workload-and IT infrastructure-related inputs such as the number of users, the number of active concurrent users, application workload types and the like. More specifically, the input values will include the following: operational cost users; operational cost staff; cost of storage (includes switching and software); cost of servers (includes networks and software); revenue per employee; number of active concurrent users; fully loaded costs; and loaded cost users.

(b) Model-Derivative Output Values (in a Descending Order of Hierarchy)

These model derived output values have been discussed above and include net business value and/or the sum of net business values; potential business value and/or the sum of potential business values; maximum business value and/or the sum of maximum business values; actual application value and/or the sum of actual application values; base application values and/or the sum of base application values; operational costs and/or the sum of operational costs, IT costs and/or the sum of IT costs; and line of business costs and/or the sum of line of business costs.

(c) Model-Derivative Intermediate Values:

These intermediate values may be seen at times to overlap with the components of the subsections (a) and (b) above. They include: effective user cost; effective cost storage; effective cost server; application value multiplier; business value of availability multiplier; business value of business flexibility multiplier; staff utilization coefficient; storage utilization coefficient; and server utilization coefficient.

### Model Input and Output Constructs

(a) Inputs As Primary And Secondary Data Constructs:

Input constructs, for example, initial data points that are not affected by other value and technology influences correspond to a specific way of data organization and value quantification that serves as an input to a model. Following are examples of various input construct types: customer inputs; best practice constructs; line-of-business specific constructs; lender-specific constructs; user-specific constructs; default constructs; and aggregation constructs.

(b) Outputs As Model Value And Technology Functional Constructs:

Output constructs correspond to a specific way of model-derived quantitative value and technology data organization, packaging and presentation that serves as deliverables. These deliverables will be expressed in business value terms (costs and/or revenue potential), while technology deliverables will be expressed in technology measurement units and effective cost. Exemplary of such output construct types are those which are business organization dependant; those which are business-to-business dependant; those which are business-to-user interaction dependant; those which are application-dependant; and those which are workload dependant.

### Underlying Value and Technology Model Types

A variety of model types fall within the purview of the instant methodology. For example, such model types will include: look-up tables and functions; flow-through models (no iterations, calculate with no target set); intelligent tables, sometimes referred to as “Intelli Tables” where outputs have in-table dependencies (minimal iterations required); models which meet a criterion (a single target) this model runs until a set target is satisfied; models which meet multiple criteria (a subset of targets), such model running until a designated subset is satisfied; models which meet all criteria (a set of targets), such model running until all set targets are satisfied; a model meeting a fixed target; a model meeting one of all targets; a model meeting N of-all targets; a model which meets all targets; a model based upon a “what-if” determination; a model based upon a “will it work” (WIWO) determination; and a model based upon a “make it work” (MIWO) determination.

### The Principle of Aggregation

In general terms, aggregation is a process for accessing the impacts of variations or various influences, concurrent or sequential, on designated aspects of a specific environment's operation. The term implies dynamic gathering, processing and reuse of the results of disparate modeling efforts involving multiple scenarios and multiple model runs (sequential or concurrent), and hierarchical stacking of intermediate outputs against a next level of modeling hierarchy. Such hierarchical stacking of aggregation fields is described in connection with the figures to follow.

The operations associated with aggregation involve collecting, collating, concatenating, filtering, combining, summarizing and otherwise processing the results of various assessment efforts (model data) in a dynamic fashion. Overall, this aggregation defines some form of a very simple or very complex relationship between organization data (artful data) and value/technology model-generated data that possesses the capacity to produce or generate quantitatively, qualitatively and intrinsically different and diverse data values. Looking to these diverse values, a quantitative dimension identifies relative sizing of specific data values in the aggregation database (or any other database). A qualitative dimension identifies qualitative differentiation of specific data points in the aggregation database (or any other database). An intrinsic dimension identifies core competency of specific data sets in the aggregation database (or any other database). Further, typically, aggregation of intermediate data-points is performed in real time.

In general, the aggregation process is implemented in two phases, to wit: (a) mathematical definitions, descriptions, relationships and models linked in the form of a set of aggregation equations; and (b) an architectural solution combining hardware and software means of data and model capture, compilation and subsequent run-time to generate corresponding aggregation results.

### Key Notions of Aggregation Methodology

This methodology combines various input types that are originated by different “impact” media such as artful constructs as discussed above, functions, models and model data-points or derivative data points. The methodology takes systematic advantage of prior experiences, results of prior effort and user input (via user databases), artful construct databases, function databases and derivative databases. As illustrated in the figures to follow, the methodology is well suited to the hierarchical nature of information technology infrastructure inner workings and the way an application value will be impacted. Further, the methodology allows for incremental responses to various changes or variations in technology, architecture, functionality, application and operational scenarios and additionally allows for incremental response to changes in an application portfolio content. An aggregated response is provided with respect to various changes in technology, architecture, functionality, application and operational scenarios as well as response to changes in application portfolio content. The methodology further aggregates incremental responses to various changes in technology, architecture, functionality, application and operational scenarios while preserving all of the intermediate results for use in other aspects of value assessment. Specifically, the method summarizes individual impacts of each application on various aspects of total value assessment in the application portfolio context, while preserving all of the individual results for use in other aspects of value assessment. Finally, the methodology specifically summarizes individual impacts of each application on various aspects of total value assessment in the workload context while preserving all the individual workload influences for use in other aspects of value assessment.

### Aggregation Scenarios

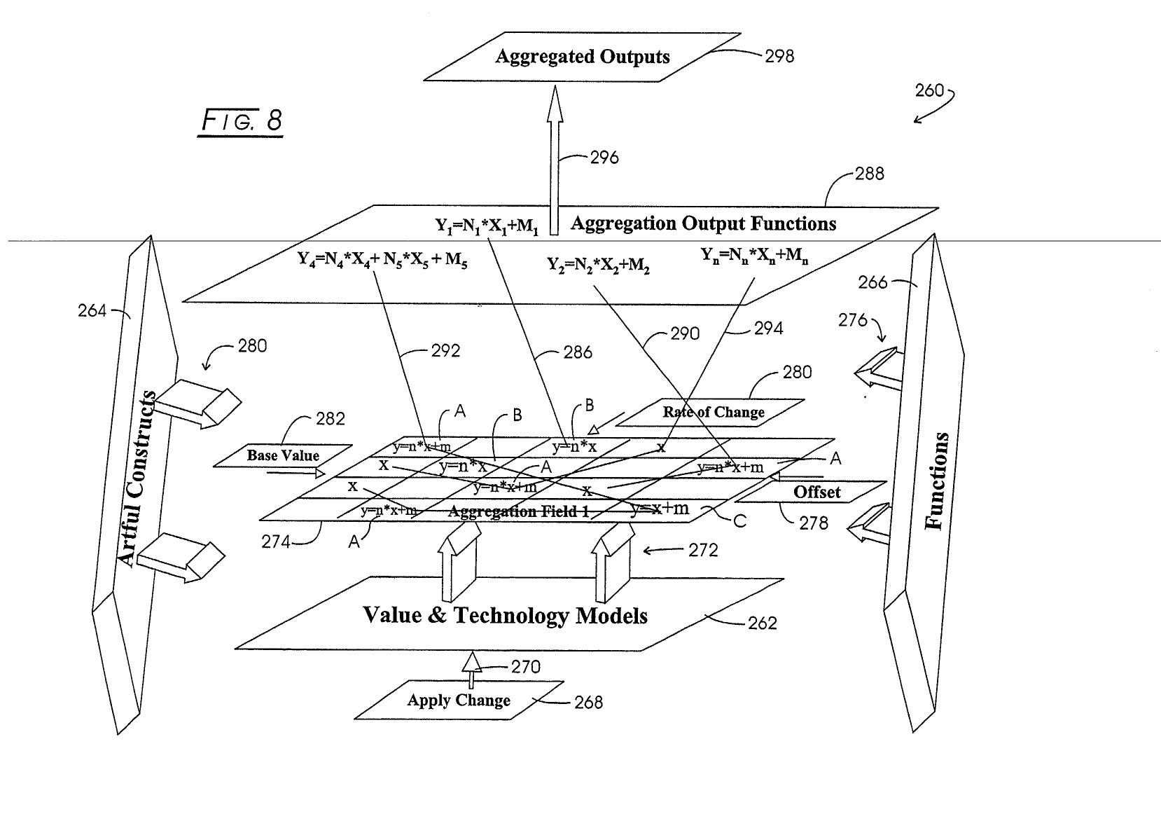

A variety of aggregation scenarios are utilized while being adherent to the same aggregation architecture. For example, the methodology may differ in the number of levels of hierarchy and respective means of accommodating and combining outside influences such as artful constructs, dependence/cost functions or models. More specifically, some aggregations may rely solely on artful approximations regarding base value, rate of change or offset coefficients in corresponding equations or sets of equations. Some aggregations may rely on artful constructs, functions and models. Others may employ functions and models only without artful constructs. Often, a determination of the depth of an aggregation field hierarchy is based upon the need to re-use intermediate results of the aggregation process. Those intermediate data-points may reside in multiple aggregation fields of the hierarchy. This arrangement will be illustrated in connection with FIGS. 8 through 14.

### Data and Functional Components of Aggregation Architecture

Artful constructs which are specific to the business organization being analyzed with respect to IT are employed for data accumulation, consolidation and qualitative refinement. These constructs may occupy a number of aggregation field cells (AF Cells) and intelligent tables (Intelli Tables). The intelligent tables constitute clusters of AF Cells with some form of mutual relationship as is illustrated in FIGS. 8-14. The intelligent tables may occupy a multi-cell space in an aggregation field and must consist of at least two cells. Subsequently, any intelligent table action may require multiple, either non-iterative or iterative steps to complete a given lookup. In this regard, an analogy may be made with spreadsheet cycles consumed for calculation and/or iterate operations. Further, the artful constructs may be combined with other variables to formulate linear or non-linear-dependence equations. The constructs typically are associated with the Base Value, while other variables may define the rate of change and the offset value for each equitation in the aggregation fields. Face value, rate of change and offset value data-points may be imported into the aggregation fields by various functions and variable complexity models. As noted above, there may be multiple levels of aggregation hierarchy with the corresponding number of aggregation fields. This organization data or data from the field and derivative data points may represent different lines of business, different enterprise types and sizes and the like. That data may be used for application value assessment, validation and calibration purposes.

### Mathematical Principles of Aggregation Methodology

Aggregation methodology forms the mathematical and architectural foundation for determining actual values of various coefficients and multipliers such as the earlier-described application value multiplier, business value of availability multiplier, business value of flexibility multiplier, business value of security multiplier and staff utilization, storage utilization and server utilization coefficient.

At the highest level, aggregation methodology allows for determination of composite results in combining multiple environmental influences, organizations, architectural solutions, operational modes, applications and workloads of various distinctions. Specific examples of aggregation functions are net application value assessment, workload aggregation, application portfolio assessment, workload mix, business flexibility, availability and security multipliers, multiple IT scenario aggregation and the like.

In the figures to follow, the point-value of aggregation is identified as: Y. In this regard, that point-value of aggregation may be expressed as follows:

Y=N₁*X₁+N2*X₂+ . . . +M (11)

In the case of a single variable, Y may be expressed as follows:

Y=N*X+N, where Y is a multiplier or coefficient. (12)

In the above expressions, X corresponds to the base value of a multiplier or coefficient that is determined by the initial state of a specific property such as availability, business flexibility or latency of a specific workload. N corresponds to the rate of change that depicts the impact of IT environment dynamism on specified IT operations and prevalent practices. Technological advances and operational practices may effect the rate of change value (for example, for a three-year lifespan of a software product, the average rate of change value would be 0.33).

M corresponds to the offset value that reflects on the relative positioning of Y point-values in a set of multiple Y-functions united by the specific commonality of interest or sense of belonging, for instance, that could be sharing the same competitive field, participating in the benchmark, aggregating in a specific application portfolio, aggregating a specific workload mix and the like. Offset values may also exhibit relative maturity or relative importance of corresponding Y properties to value model users. If artful constructs, X, N or M may be represented by integers or fractions. X, N, and M also may be functions of other variables or may be complex multi-dimensional models, or any combination thereof. All of X, N or M expressions may require calibration.

In the discourse to follow in conjunction with FIGS. 8 through 14, certain aggregation cell expressions are utilized which are alphabetically identified as follows:

(A)y=n*x+m

(B)y=n*x

(C)y=x+m

Referring to FIG. 8, a mathematical diagram representing an aggregation architecture with a single layer of hierarchy is represented generally at 260. Diagram 260 shows the utilization of value and technology models as at symbol at 262 in conjunction with business organization specific artful constructs represented at symbol 264 and model developed or processed functions represented at symbol 266. As represented at symbol 268 and arrow 270, a variation or change, for example, the addition of ten personnel is applied to the models 262 which in turn input data as represented at arrow pair 272 to a single hierarchy aggregation field represented by the plane 274. Also applied to this aggregation field are function inputs represented at arrow pair 276 and, particularly, offset points as represented at symbol 278. In similar fashion, the business organization specific data represented at symbol 264 is applied to the aggregation field 274 as represented at arrow pair 280. The point inputs (x) are applied as represented by the base value symbol 282. Rate of change points (n) are applied to the aggregation field 274 as represented at symbol 284.

Mathematical operations are carried out within the aggregation field 274 either in a direct fashion or in a sequential fashion. In this regard, a mathematical coordinating line 286 shows the direct outputting of the point value of aggregation, Y₁ at the aggregation output function plane 288. By contrast, the mathematical coordinating line 290 carries out a succession of two manipulations to derive the aggregation output, Y₂. In similar fashion, mathematical coordinating line 292 manipulates a base value point input through three successive expressions, A, C and A to develop point value of aggregation, Y₄. Finally, mathematical coordinating line 294 represents a sequence of mathematical manipulations involving expression A to provide the point value of aggregation, Yₙ. These aggregation output functions then, as represented at arrow 296 and symbol 298 evolve into finely developed aggregated outputs represented at symbol 298.

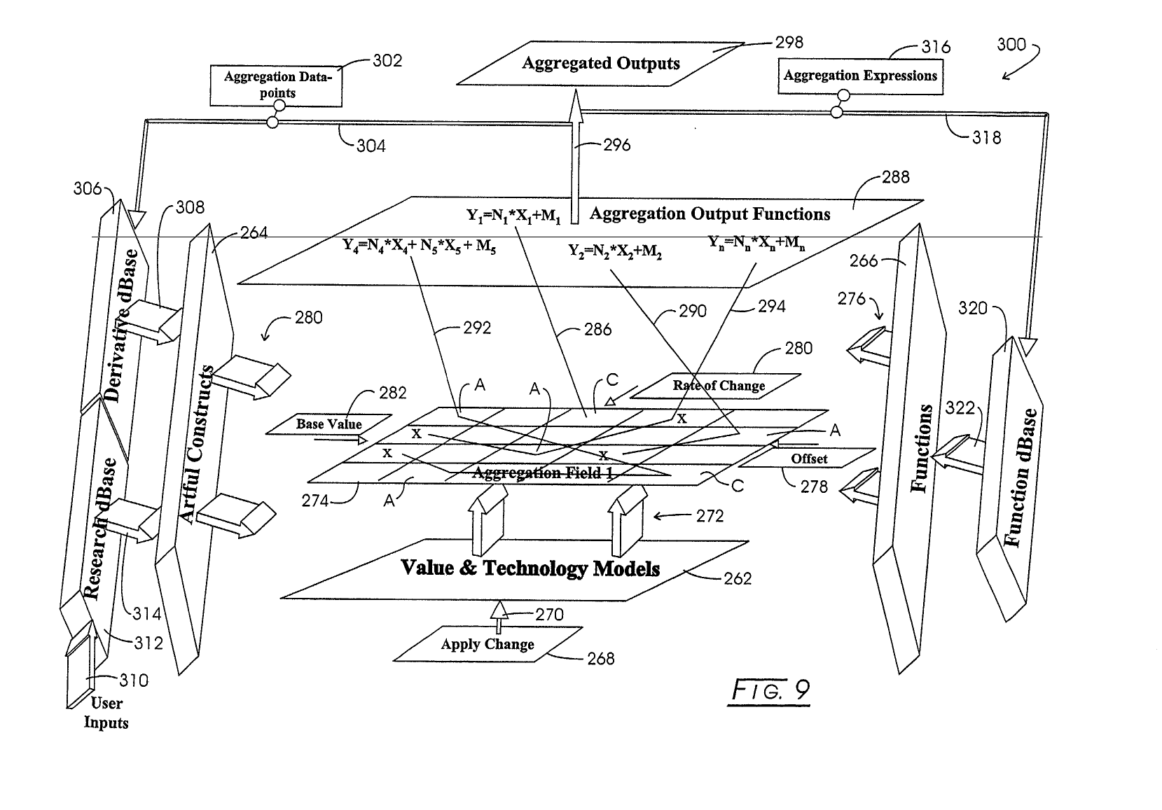

Referring to FIG. 9, a mathematical diagram is represented in general at 300. The diagram 300 incorporates all of the components and outputs described above in connection with FIG. 8. Accordingly, components of commonality between these two figures are represented with the same numeration. In the figure, database information is both used and developed in conjunction with the aggregation outputs represented at arrow 296. In this regard, as represented at block 302 and arrow 304 aggregation data points are submitted to an earlier described derivative database represented at symbol 306. Preexisting data within that database is submitted to the artful constructs input 264 as represented at arrow 308. Unprocessed data as developed by the specific business organization identified as “user inputs” at arrow 310 is introduced to a research database represented at symbol 312. Data from database 312 is supplied to the artful constructs compilation 264 as represented at arrow 314. The aggregation expressions evolved at the output function 288 also are directed to a database. In this regard, aggregation expressions as represented at block 316 and arrow 318 are directed to an earlier-described function database represented at symbol 320. In addition to enhancing the value of the database 320, that same database is employed to feed or support the functions input 266 as represented at arrow 322.

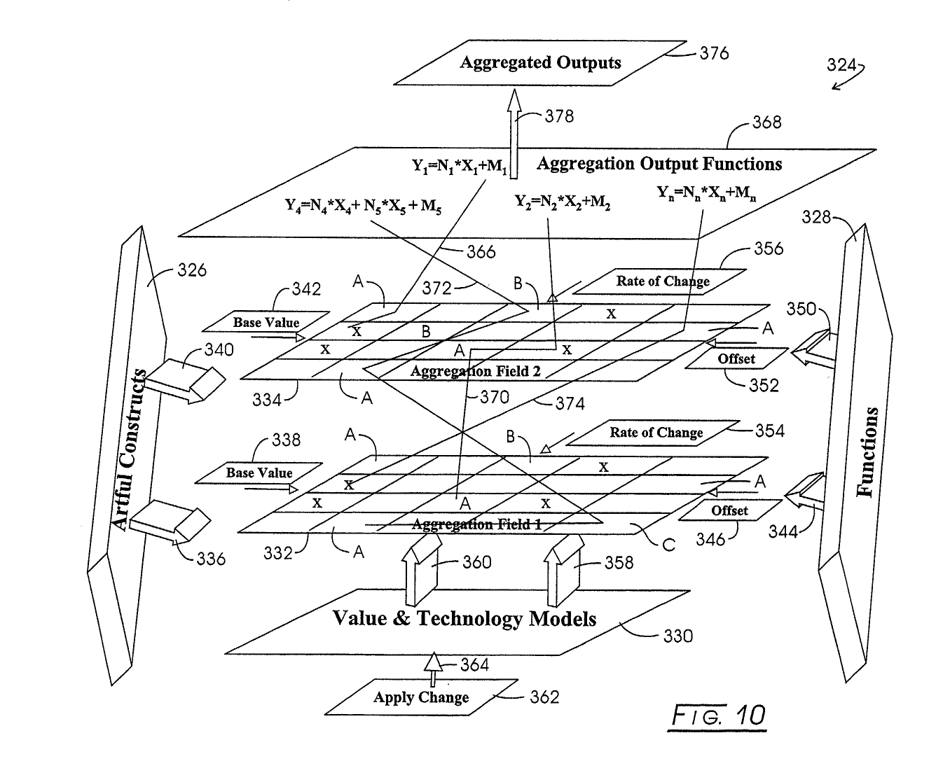

Referring to FIG. 10, a mathematical diagram is represented in general at 324 which incorporates both the earlier-described aggregation field cell-to-cell manipulation and, additionally provides for a field-to-field interaction. In the figure, the business organization specific artful constructs are represented at symbol 326. Function inputs are represented at symbol 328 and the value and technology models are represented at symbol 330. A first multi-cell aggregation field is represented at plane 332 and a second hierarchical aggregation field is represented at plane 334. Artful construct inputs to hierarchical plane aggregation field 332 are represented at arrow 336 and base value data points are applied as represented at symbol 338. Correspondingly, artful construct inputs to the second aggregation field 334 are represented at arrow 340, while the corresponding base value point inputs are applied to the multi-cellular field represented at plane 334 as represented at symbol 342. Preprocessed data from the function input 328 is applied to the initial or lower hierarchical aggregation field at plane 332 as represented at arrow 344 along with corresponding offset data as represented at symbol 346. Correspondingly, function data inputs through the upper hierarchical aggregation field represented at plane 334 are represented at arrow 350, while offset data is shown applied from symbol 352.

Rate of change data points are shown applied to a lower hierarchical aggregation field represented at plane 332 as shown at symbol 354 while, correspondingly, such data is shown applied to the aggregation field represented at plane 334 as shown at symbol 356. As before, inputs from the value and technology models are represented at arrows 358 and 360 and a variation or applied change is illustrated in conjunction with symbol 362 and arrow 364.

Application of a change or variation as is represented at arrow 364 is illustrated as evoking a variety of intra-field and inter-field interactions. For example, mathematical coordinating line 366 involves only expression A in deriving the point value of aggregation Y₁ as shown at the aggregation output function plane 368. By contrast, mathematical coordinating line 370 is shown involving expression A in the aggregation field represented at 332 but undergoes an intracellular reaction in conjunction with the aggregation field represented at plane 334 to evolve the point value of aggregation Y₂ at plane 368. Math coordinating line 372 carries out intracellular activity within the aggregation field at plane 332 in conjunction with expressions A and C and then carries out a similar interaction within the aggregation field represented at plane 334 in conjunction with expressions A and B to evolve the point value of aggregation Y₄ shown at plane 368. Finally, mathematical coordinating line 374 shows a movement of data from the aggregation field 332 without treatment to a singular cell treatment in conjunction with expression A at the aggregation field represented at plane 334 to evolve the point value of aggregation Yₙ shown at plane 368. The aggregated outputs are shown in the figure at symbol 376 in conjunction with arrow 378.

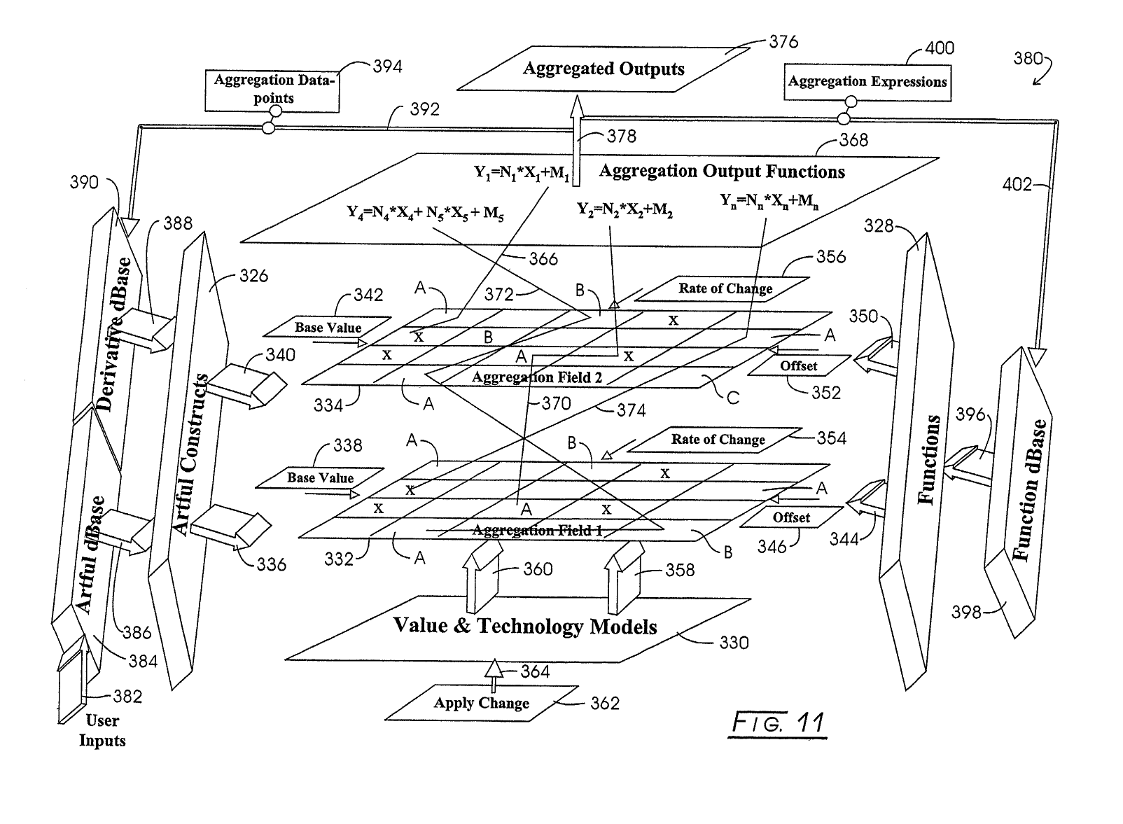

Referring to FIG. 11, a mathematical diagram is shown in general at 380. Diagram 380 employs diagram 324 as described in connection with FIG. 10 in conjunction with the building and using of three databases in a manner, for example, described in conjunction with FIG. 9. Accordingly, components of commonality between mathematical diagram 324 and diagram 380 are identified with the same numeration. In the figure, organization specific inputs identified as “user inputs” are applied, as represented at arrow 382 to an artful database represented at symbol 384. Those inputs as well as previously obtained user or business user or organization specific data are supplied to the artful constructs function 326 as represented at arrow 386. Also supplied to the function 326 is processed data from a derivative database as represented at arrow 388 and symbol 390. Beneficial additions are made to the database 390 from the aggregation data points as represented at plane 368. This addition is represented at arrow 392 and block 394.

Database retained expressions are supplied to the functions data input at symbol 328 as represented at arrow 396 and symbol 398. The function database 398 itself is enhanced by the aggregation expressions generated with the instant system as represented at block 400 and arrow 402.

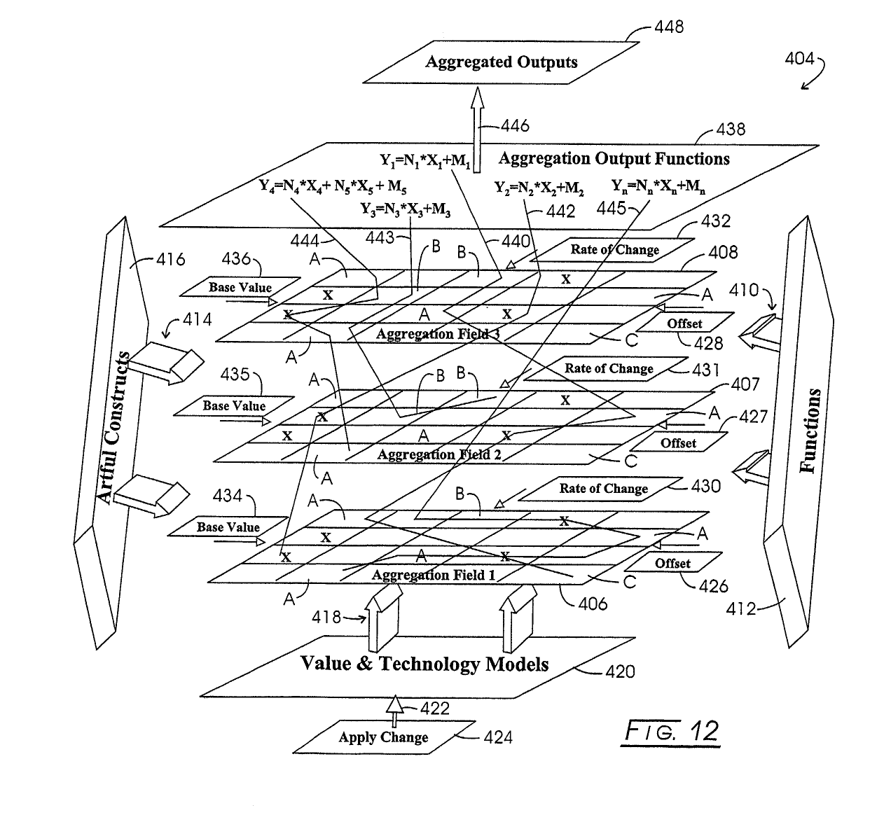

Referring to FIG. 12, a mathematical diagram 404 is illustrated which incorporates three hierarchical aggregation fields. These three fields are represented at planes 406-408. Function inputs to the aggregation fields represented at planes 406-408 are provided as represented at paired arrows shown generally at 410 and symbol 412. Similarly, the organization specific artful construct function inputs are represented at paired arrows shown generally at 414 and symbol 416. Value and technology model inputs, as before, are represented in general at paired arrows 418 and symbol 420. A variation or applied change is represented at arrow 422 and symbol 424. Offset inputs to the fields represented at planes 406-408 are shown respectively at symbols 426-428. Correspondingly, rate of change data is shown being applied to the fields represented at planes 406-408 as represented respectively at symbols 430432, and base value inputs are represented respectively at symbols 434-436.

Mathematical activity can be intra-field as well as inter-field as represented by mathematical coordinating lines in the figure. For example, the point value Y₁ as shown at the aggregation output function plane 438 is associated with mathematical coordinating line 440 which is evolved with dual interactions in all three aggregation fields represented at planes 406-408. The point value of aggregation, Y₂, is evoked as represented at coordinating line 440. Line 440 evolves with single interactions in the aggregation fields represented at planes 406 and 407 and dual interactions at the aggregation field represented at plane 408. Point value of aggregation Y₃ is developed in conjunction with mathematical coordinating line 443 which is seen to evolve with dual interactions in each of two aggregation fields as represented at planes 407 and 408. Point value aggregation, Y₄, is evolved from the aggregation fields represented at planes 407 and 408 and extends directly from the field represented at plane 407 to triple interactions at the highest aggregation field represented at plane 408. Point value of aggregation Yₙ is evolved as represented at mathematical coordinating line 445 which indicates six intra-cellular mathematical activities at the aggregation field represented at plane 406, a single interaction at the aggregation field represented at plane 407 and a correspondingly single interaction at the aggregation field represented at plane 408. The aggregated outputs are represented at arrow 446 and symbol 448.

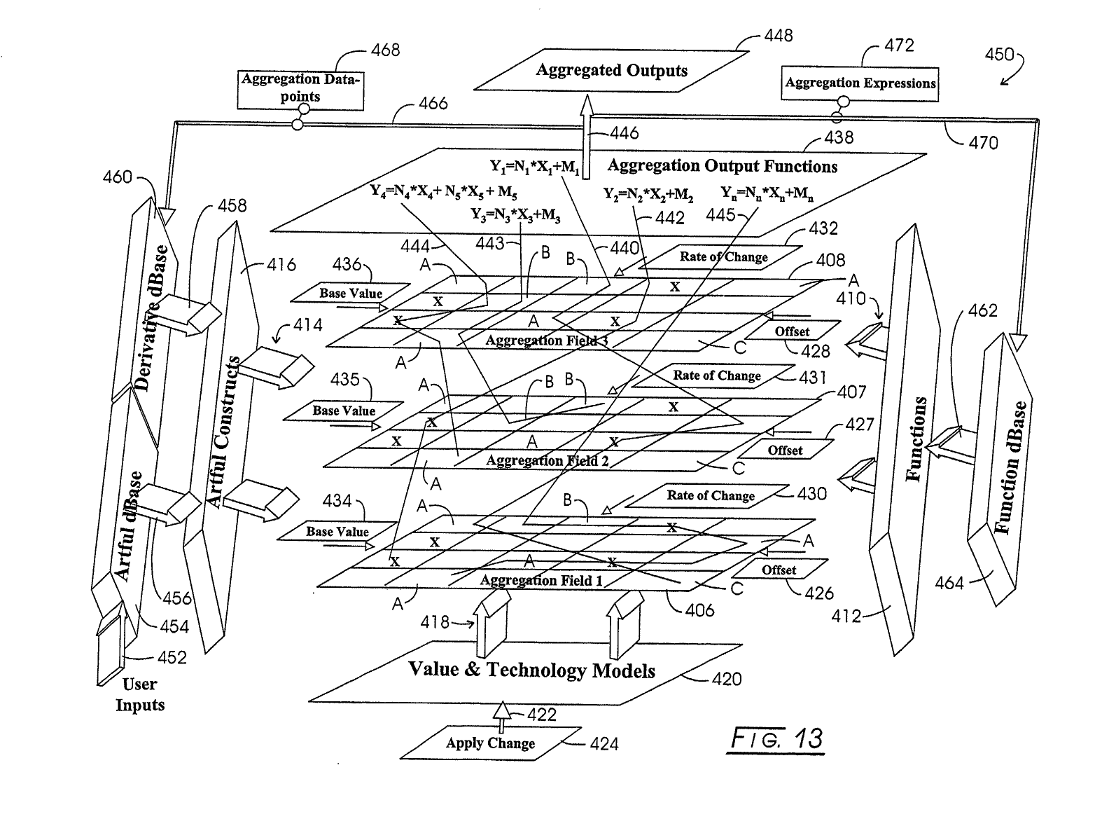

Referring to FIG. 13, a mathematical diagram is shown in general at 450. Diagram 450 is identical to that described at 404 in connection with FIG. 12 but includes three database components in the manner of FIGS. 9 and 11. Accordingly, components which are common with FIG. 12 are identified by the same numeration. In the figure, business organization specific inputs or user inputs are identified at arrow 452 as being supplied to an artful database represented at symbol 454, those components as well as earlier stored components of the database being applied to the artful construct function 416 as represented at arrow 456. Process data is made available to the artful construct function 416 as represented by arrow 458 and the derivative database symbol 460. Similarly the functions in input represented at symbol 412 is fed or enhanced from a function database as represented at arrow 462 and symbol 464. The derivative database is shown being fed or enhanced with aggregation data points as represented at arrow 466 and block 468. Similarly, the function database represented at symbol 464 is updated and enhanced as represented at arrow 470 and block 472.

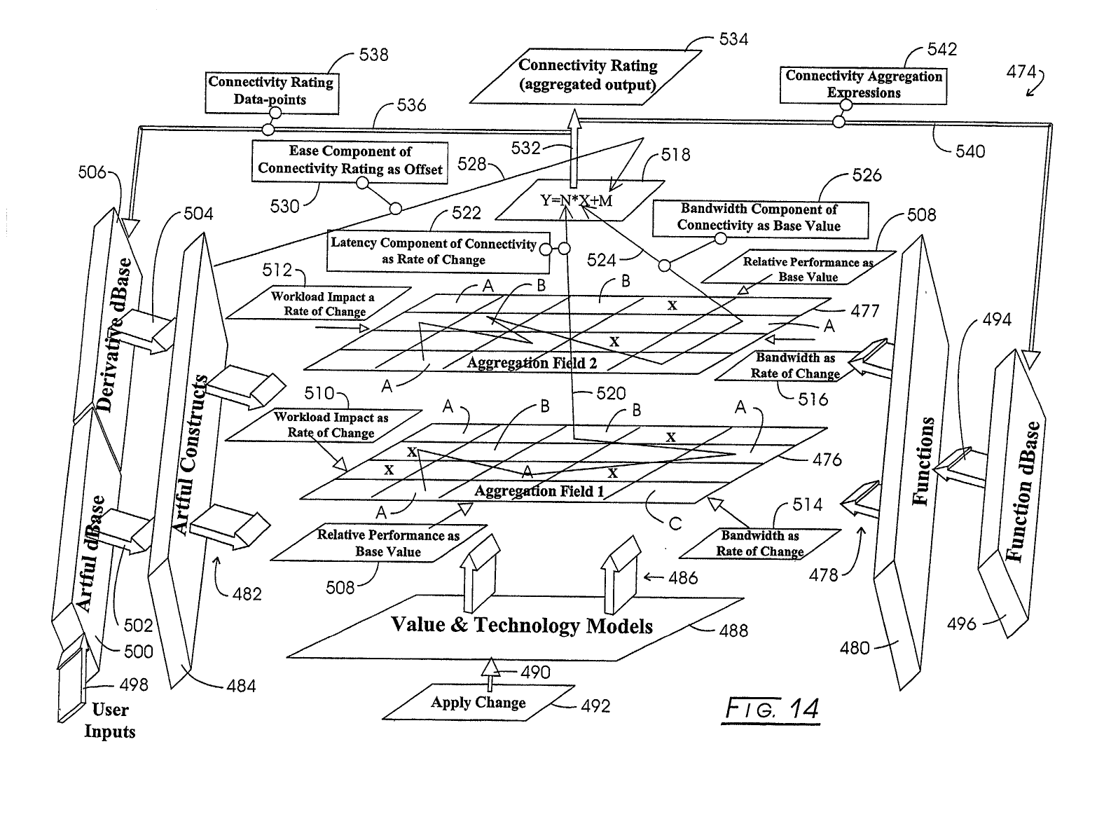

Referring to FIG. 14, an exemplary aggregation exercise representing an assessment of connectivity is presented. The figure shows a mathematical diagram represented generally at 474 which somewhat resembles the diagram of FIG. 11. In this regard, note that the diagram 474 has two principle aggregation fields represented at planes 476 and 477. Processed or functions inputs are directed to these matrices as represented by an arrow pair shown generally at 478 and symbol 480. Similarly, artful or business specific constructs are applied to the fields as at planes 476 and 477 as represented by arrow pair 482 and symbol 484. Inputs to the matrix from value and technology models are represented in general by arrow pair 486 and symbol 488 and variations or applied changes representing competitive scenarios are shown as an arrow 490 and symbol 492. Expression inputs to the functions feature 480 are shown as emanating from a function database as represented at arrow 494 and symbol 496. Similarly, organization specific inputs or user inputs are submitted to an artful database as represented at arrow 498 and symbol 500. That database then feeds or enhances the artful constructs function 484 as represented at arrow 502. A processed data carrying derivative database also functions to feed the artful constructs function 484 as represented at arrow 504 and symbol 506.

For the instant demonstration, the connectivity attribute is rated on the basis of three-dimensional metrics, to wit Ease-Attainability, Latency, and Bandwidth. The changes which may be applied as described in connection with arrow 490 may, for example, be provided as the following competitive scenarios: (1) open SAN (storage area network), (2) monolithic SAN, (3) network attached storage (NAS), and clustered file system (CXFS). System size data also is provided, i.e., representing low end, mid range and high end. The component workloads evaluated are decision support software (DSS), online transaction processing (OLTP), and internet service provider (ISP). Derivative workloads or workload mix is concerned with the following aspects: (1) business intelligence, (2) business processing, (3) collaborative, (4) industry operational system mix, for example, industry NT mix, (5) collaborative/internet-heavy, (6) technical, and (7) industry operating system mix such as Unix. The relative performance of component workloads may be developed as follows: (1) performance in DSS (four data points, one for each competitive scenario), (2) performance in OLTP (four data points), one for each competitive scenario), and (3) performance in ISP and (4 data points, one for each competitive scenario). The bandwidth component of connectivity is provided as follows: (1) relative importance of bandwidth component of connectivity at the low end (four data points, one for each competitive scenario), (2) the relative importance of bandwidth component of connectivity at the midrange (four data points, one for each competitive scenario), and (3) the relative importance of the bandwidth component of connectivity at the high end (four data points, one for each competitive scenario).

With the above data, then for each of the three system sizes, and for each of the four competitive scenarios, and for each of the seven workloads, the methodology formulates connectivity aggregation equations.

Returning to FIG. 14, symbol 508 indicates that relative performance as a base value is mapped into the workload mix as a performance model derivative value of greater than or less than one. It is applied to the aggregation field at a lower hierarchical level represented at plane 476 and, additionally, as represented at block 508 is inputted to the next higher aggregation field represented at plane 477. Similarly, workload impact is inputted as the rate of change to the lower aggregation field at plane 476 as represented at symbol the 510. This same form of input is provided to the higher aggregation field at plane 477 as represented at the symbol 512. The relative importance of a bandwidth component of connectivity at the low-end, high-end or midrange is introduced directly into the lower aggregation field represented at block 476 also as a rate of change as represented at symbol 514. Similarly, bandwidth as a rate of change is introduced to the higher aggregation field represented at plane 477 as indicated at symbol 516. The aggregated output functions are represented at symbol 518 which is seen to incorporate the expression, A.

With the arrangement shown, the output of the lower aggregation field represented at plane 476 is indicated in conjunction with the mathematical coordination line 520 which is directed to the rate of change component, N. In this regard, this output from the lower aggregation field corresponds with a wait and see component of connectivity as rate of change as represented at block 522. The corresponding output of the higher aggregation field at plane 477 is represented at mathematic coordinating line 524 which is seen directed to the X or base value component of the expression at symbol 518. In this aggregation field at plane 477, the latency component of connectivity rating is assessed in a fashion similar to a bandwidth component of connectivity rating assessment. The output of this aggregation field at plane 477 corresponds to a bandwidth component of connectivity as a base value. This is represented by block 526. Finally, the offset value, M at the expression within symbol 518 is adjusted with an ease component of connectivity rating as represented at mathematical coordinating line 528 which is seen to be directed directly from the artful constructs function 484 and is labeled at block 530. In effect, this input to the expression at symbol 518 represents a single cell third aggregation field. In general, the outputs represented at lines 520 and 524 are queued at four columns or buffers of multiple entries, each such buffer representing one of the above-noted scenarios. The output of the system as represented at arrow 532 and symbol 534 constitutes the total connectivity rating which is queued into a buffer. As before, the connectivity rating data points are introduced into derivative database represented at symbol 506 as illustrated in connection with arrow 536 and block 538. Correspondingly, the connectivity aggregation expressions from the output are directed to the function data base represented at symbol 496 as illustrated in connection with arrow 540 and block 542.

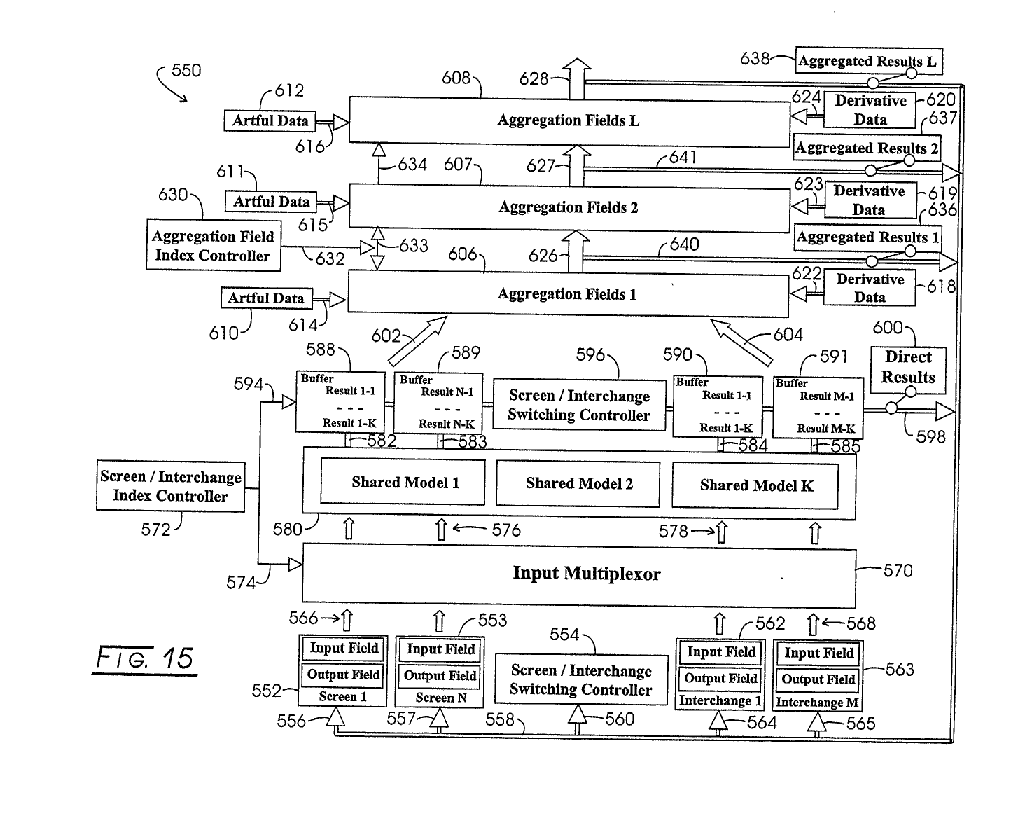

The discourse now turns to the structure utilized in implementing an aggregation based analysis. Referring to FIG. 15, an initial embodiment for a system configured for carrying out the methodology of the invention is revealed in general at 550. System 550 includes manual input terminal assemblies, the number of which may vary depending upon the applications being evaluated. Accordingly, the input terminal assemblies 1 through N are represented at blocks 552 and 553. Each of these assemblies as at 552 and 553 includes an output, for example, including a visibly perceptible screen as well as an input field for receiving organization specific artful data and outputting such data. In the latter regard, each assembly as at 552 and 553 incorporates an output field and is controlled by a switching controller represented at block 554. The input fields of the terminal assemblies 552 and 553 also may receive conveyed treated attribute data as represented at respective arrows 556 and 557 extending from a data channel represented at 558.

The controller component 554 also may receive such treated data as represented at arrow 560 and additionally functions to control one or a plurality of interchange assemblies. In the latter regard, the number of such interchange assemblies will vary in relation to the number of applications being investigated and are shown as being present from interchange number 1 to interchange M as represented at respective blocks 562 and 563. Each of the interchange assemblies are shown to have an input field for receiving treated data for the purpose of updating tables and the like which are present in their output fields. Such input is represented by arrows 564 and 565.

Under the control of the switching controller 554, the output fields of terminal assemblies at 552 and 553, are represented by arrow array 566. Correspondingly, the output fields of interchange assemblies 562 and 563 are shown being outputted at arrow array 568.

For the embodiment of system 550, these outputs as represented by arrow arrays 566 and 568 are presented to the input of an input multiplexor 570. Multiplexor 570 performs under the control of a subset component of the screen/interchange switching controller 554 as represented at block 572 and arrow component 574. Accordingly, a controlled sequence of outputs is presented, as represented at arrow arrays 576 and 578 to a plurality of 1 through K shared mathematical models identified within block 580. The model programs are indicated to be shared models which are shared and reused with respect to deriving treated derivative data for outputting at a computer bus as represented at 582-585. In general, smaller models are more manageable when utilized in a shared environment.

The bus function 582-585 is seen directed to buffer memory represented at blocks 588-591. Buffers 588-591 are inter-coupled with the computer bus and are subject to index controlling as represented at Index Controller block 572 and arrow 594 and further subject to switching control as represented at Switching Controller block 596. The latter control permits the conveyance of the shared model results back to the input fields of terminals 552 and 553 as well as interchanges 562 and 568 as represented by arrow 598 extending to data channel 558 and identifying block 600. Buffers as at 588-591 provide, for example, for carrying out queuing functions as well as aggregation re-ordering and a changing of priorities.

Model derived treated attribute data as well as business organization specific artful data inputted, for example, from terminal assemblies 552 and 553 as well as previously evolved derivative data is submitted to one or more multi-cell aggregation fields retained in temporary memory as represented in part at arrows 602 and 604. For system 550, aggregation fields 1 through L are represented at respective blocks 606-608. Business organization specific artful data as inputted at the terminal assemblies 552 and 553 is applied to the aggregation fields as at 606-608 as represented at respective blocks 610-612 and associated arrows 614-616. The treated attribute data derived from the model function 580 as well as any other such derivative data also is introduced to the aggregation fields as at 606-608 as represented by respective blocks 618-620 and corresponding arrows 622-624. The vector output of the aggregation fields as at 606-608 may propagate through the field hierarchal architecture, at times mathematically interacting on the way and at times extending directly to the final value result. These outputs are represented in the instant figure as respective arrows 626-628. The interactions and actions are under computer control as represented by the index controller control subset represented at block 630 and arrows 632-634. Control provided as represented at block 630 also directs the aggregated results of each of the aggregation fields 606-608 to the data channel 558 as represented at respective blocks 636-638 and arrows 640 and 641.

As before, data channel 558 functions to convey the final results generated from the aggregation fields back to the terminal assemblies as at 552 and 553. Such data can be published at outputs such as user screens and/or be employed with graphics generating software modules to facilitate an understanding of the final value metrics. This information will also be seen to feed or enhance the earlier-described databases.

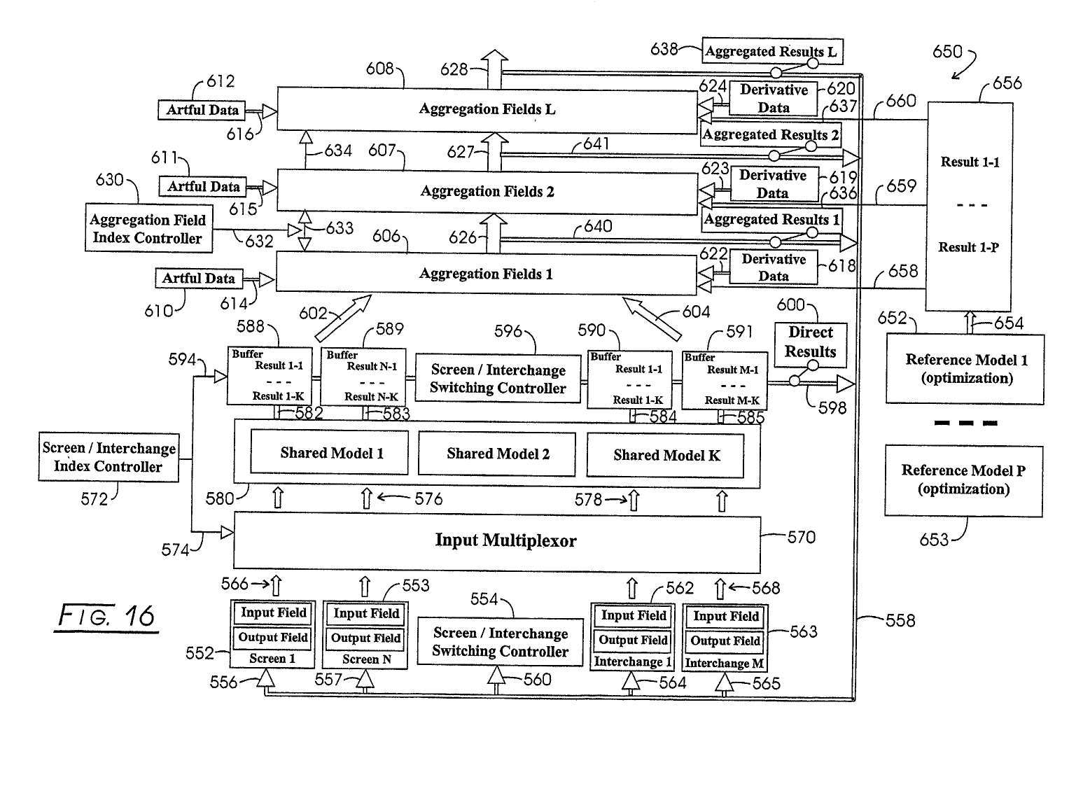

Referring to FIG. 16, an enhancement of the system architecture 550 is presented as represented generally at 650. Components which are common between the system 550 and this system 650 are identified with the same numeration. However, the system 650 is seen to incorporate one or a plurality of reference models, for example, models 1 through P as are represented respectively at blocks 652 and 653. These reference models are optimizing models which run various optimization algorithms that typically require many times more computational cycles than, for example, shared models 580. These dedicated reference models in general, perform in parallel with other models of the system, for example, as at 580 and their result, as represented at arrow 654 and block 656, is sometimes referred to as an “adaptive optimization”. These results are shown by arrows 658-660 to be propagated into respective aggregation fields 606-608. For this architecture, the reference models generally affect the rate of change in the aggregation equations. The dedicated models 652-653, while enhancing the scope and accuracy of the aggregation operations at field 606-608, may also feed or enhance other models within the system, for example, the shared models represented at block 580 or other dedicated models as are discussed later herein.

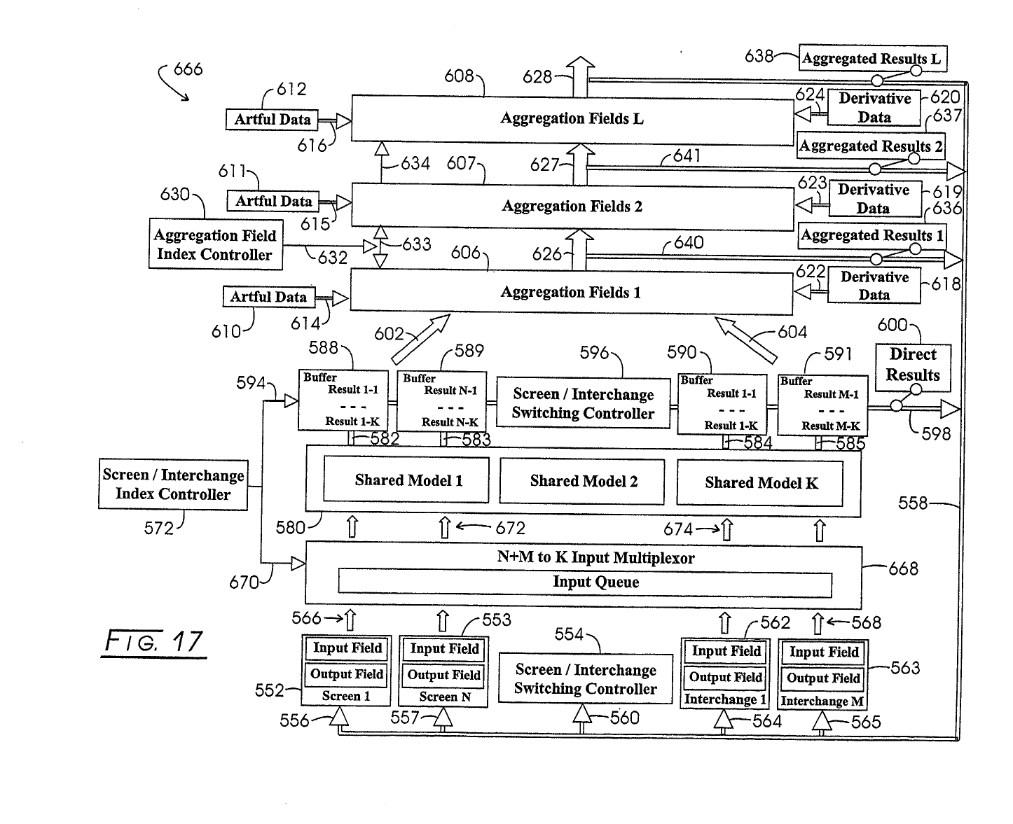

Referring to FIG. 17, a system architecture similar to that described in connection with FIG. 15 is presented. However, with this architecture, an enhanced multiplexor function is implemented. Accordingly, with the exception of the latter component, each of the elements of the system at 666 is provided with the same numeration as provided in conjunction with system 550 of FIG. 15. In the figure, it may be noted that the outputs 566 of the terminal assemblies as well as the output of the interchange assemblies as at 568 are directed to a multiplexor function represented at block 668 which is under the control of index controller 572. However, the extent of that control is enhanced as now represented by the control input arrow 670. The multiplexor function 668 now incorporates an input queue with this arrangement, the output fields of the terminal assemblies 552-553 and the interchange assemblies 562-563 become feed input queue entries. In this regard, the entire input volume may be split into multiple sub-volumes, replicated or overlapped for the purpose of forming separate input queues for the shared models 580. However, since these models are shared, only one input vector can be presented to their inputs at a given time. The latter arrangement may be carried out by multiplexing two resident entries to an output register. With the flexibility of adding the input queue, the request processing order and handling pattern can be altered or influenced by internal or external activities. For example, display screen or interchange oriented requests can be prioritized as high or low priority requests or removed (flashed out). These procedures may provide a request arrangement resulting in request compression or destage optimization. Request compression occurs when non-process requests are replaced in the input queue by newly generated requests from the same source. Destage optimization involves the re-ordering and/or reducing the number of requests exiting an input queue as opposed to requests entering the queue. An output register of the multiplexor may, as represented by arrow arrays 672 or 674, present multiple sets of input data-points to the shared models and resulting multiple sets of output data-points from all shared models may be then placed into the corresponding buffers 588-591 as output vectors. It may be noted that data retrieval from these output buffers can be prioritized based upon a variety of aggregation computational considerations.

As before, some or all of the output vectors from the aggregation fields can be conveyed back to the outputs or screens of the terminal assemblies 552-553 as well as to interchange tables at the interchange assemblies 562 and 563. Graphics generating software modules may be employed to facilitate understanding of the data from the terminal assemblies 552 and 553.

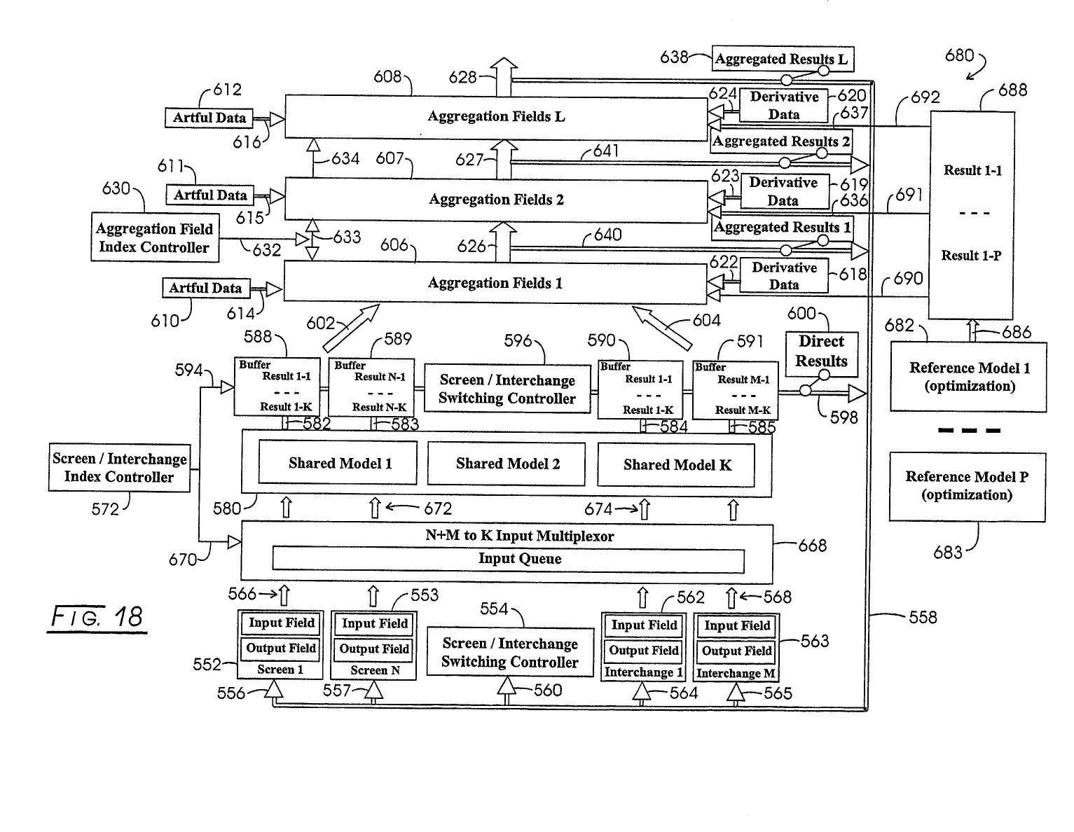

Referring to FIG. 18, a system is represented generally at 680 having an architecture which is the same as that described in connection with FIG. 17 but incorporating the earlier-discussed adaptive optimization feature derived from one or more reference models. Accordingly, components of the system 680 which are common with the components of system 666 are provided the same identifying numeration. In the figure, reference models 1 through P are represented by respective blocks 682 and 683. These models provide results or outputs as represented at arrow 686 and block 688. As represented by arrows 690-692 the outputs of these dedicated reference models are fed to the aggregation fields as shown respectively at 606-608. With this form of architecture, as before, the optimization algorithms run by the reference models typically will affect the rate of change in the aggregation equations. As noted earlier herein the reference models may be shared models, dedicated models and/or aggregation fields to extend the scope and accuracy of the aggregation operations. The reference models typically require many more computational cycles than the shared models described in connection with block 580.

Results of the last stage aggregation as at 608 as well as the intermediate hierarchical stages are directed for publication or output at the terminal assemblies 552, 553 as well as to the interchange assemblies as at 562 and 563. Graphic software modules may be employed to enhance the published results at the terminals 552 and 553.

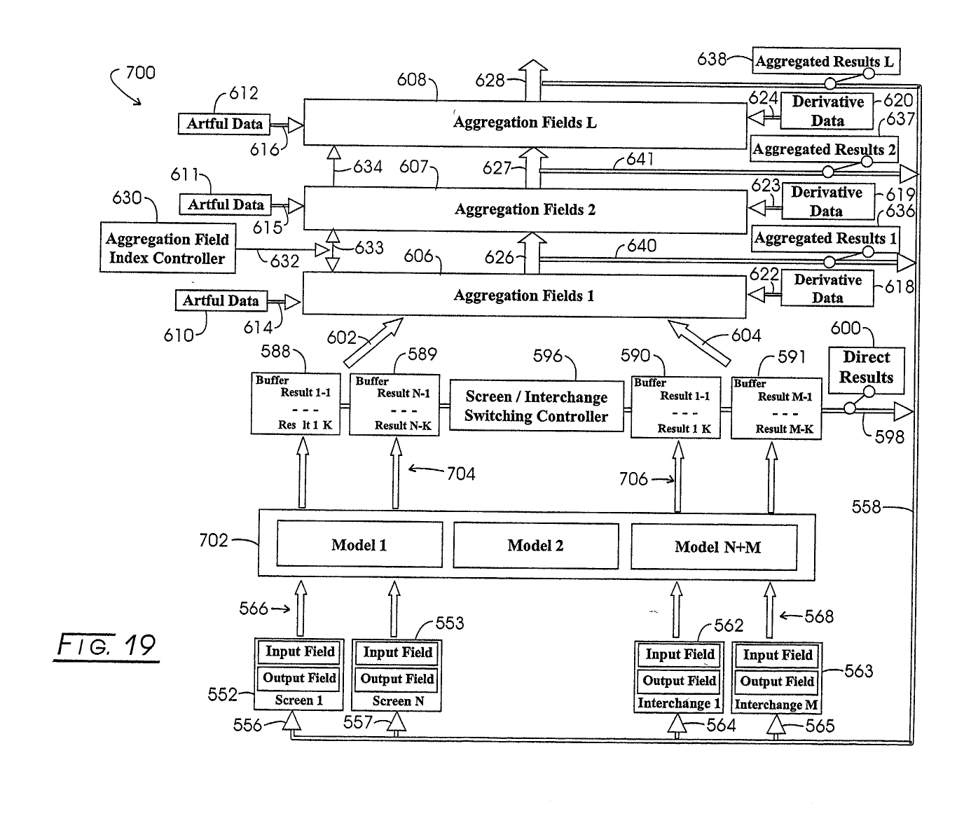

Referring to FIG. 19 a more simplified system is represented generally at 700. The architecture of this system, while somewhat similar to the system 550 of FIG. 15, eliminates the input multiplexor function 570 and substitutes dedicated models in place of the shared models of system 550. By eliminating the shared model approach, a very high or rapid performance becomes available to the IT analyst. In the figure, a sequence of dedicated models is represented at block 702. The outputs of these dedicated models are represented at arrow arrays 704 and 706. The remaining components of system 700 are the same as those described as system 550 in connection with FIG. 15 and carry the same identifying numeration as provided in the latter figure. With this dedicated model arrangement, the output fields of terminal assemblies 552 and 553 as well as the output fields of interchange assemblies 562 and 563 are connected directly to the inputs of the dedicated models. In this regard, there is at least one model per terminal assembly or interchange assembly, the models performing in parallel fashion. It follows that the total number of individual dedicated models will correspond to the sum of all terminal assemblies and interchange assemblies. However, it may be noted that individual models may be an accommodation of different dedicated models and the same model structure architecture may be replicated.

The outputs of the dedicated models as represented at arrow arrays 704 and 706 may be stored in the upper memories 588-591 and, preferably, there is at least one dedicated buffer memory per terminal assembly or interchange assembly. It may be noted that the buffers 588-591 can perform on a prioritized or otherwise disciplined basis and can perform a queuing process in conjunction with the outputting of vectors as represented at arrows 602 and 604.

As before, the outputs of the aggregation fields 606-608 are redirected to the terminal assemblies 552-553 as well as the interchange assemblies 562-563 as represented by the data conduit 558. In general, the terminal assemblies 552-553 will provide an output representing some form of visually perceptible readout and may employ graphic software to facilitate an understanding of such readouts.

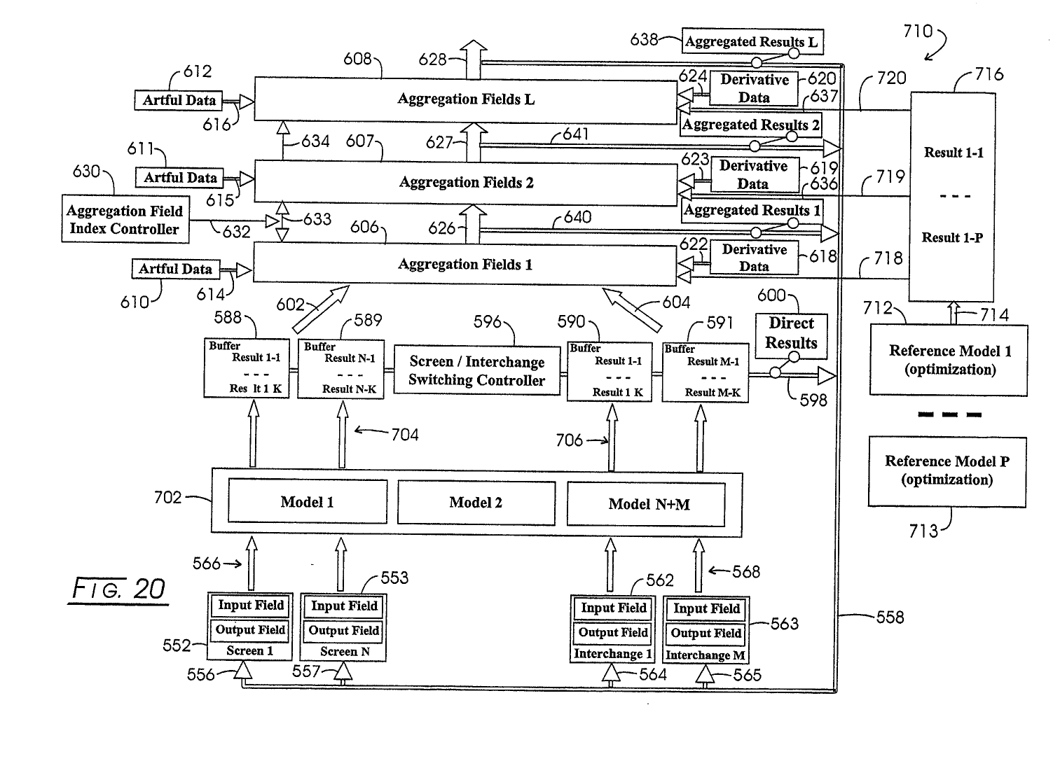

Referring to FIG. 20, a system is represented in general at 710 having an architecture identical to that shown at 700 in FIG. 19. Accordingly, identifying numeration of the common components of these systems remains the same. However, as in the case of system 650 described in connection with FIG. 16 and system 680 described in connection with FIG. 18, an adaptive optimization is added through the utilization of reference models. In this regard, the reference models are represented at blocks 712 and 713 corresponding with reference models 1 through P. The outputs of these models are represented by arrow 714 and results block 716. For the instant demonstration, these results function to feed the aggregation fields 606-608 as represented by respective arrows 718-720. The reference models 712-713 generally run a variety of optimization algorithms which require substantially heightened computational cycles as opposed to, for example, shared models. While not illustrated, the outputs of these reference models may also feed the dedicated models. As before, the ultimate readout of system 710 generally will be at the terminal assemblies 552-553 and may be supplemented with graphic software and the like to enhance its understanding.

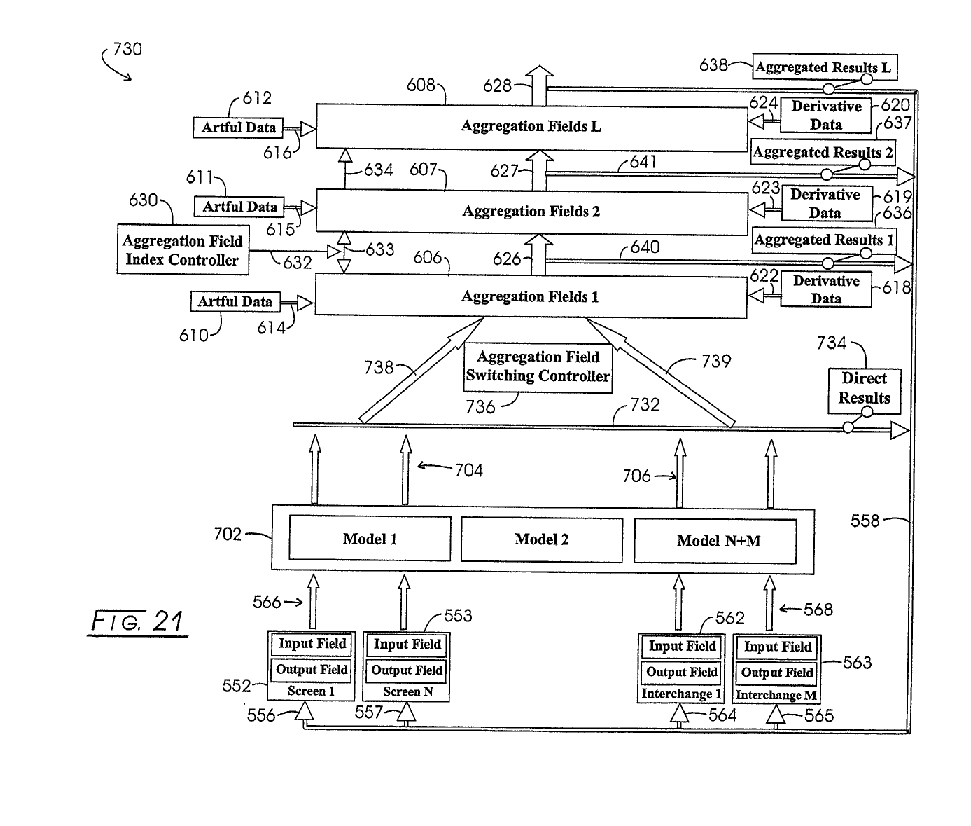

Referring to FIG. 21, a system represented generally at 730 is illustrated which provides an architecture similar to system 710 described in connection with FIG. 20. Accordingly, components which are common between these systems are identified with the same numeration. However, system 730 provides a flow through architecture with no buffer memory. Accordingly, the outputs of the dedicated model 702 as represented at arrow arrays 704 and 706 initially are directed to data channel 558 as represented at arrow 732 and block 734 under the control of an aggregation field switching controller represented at block 736. The output results of the model are directly propagated into designated aggregation fields without intermediate processing, re-ordering and/or change in priorities as represented by arrow pair 738-739. Accordingly, the system 730 is comparatively simple and quite rapid in its performance. Under the control 736, concurrent independent aggregation procedures are performed essentially immediately with internal states not being influenced by external actions or activity. The output vectors from the aggregation fields are conveyed to a readout, as may be provided in conjunction with terminal assemblies 552 and 553, as well as being conveyed to the interchange assemblies 562 and 563. As before, graphics software modules may be employed to facilitate an understanding of the aggregation field hierarchical outputs.

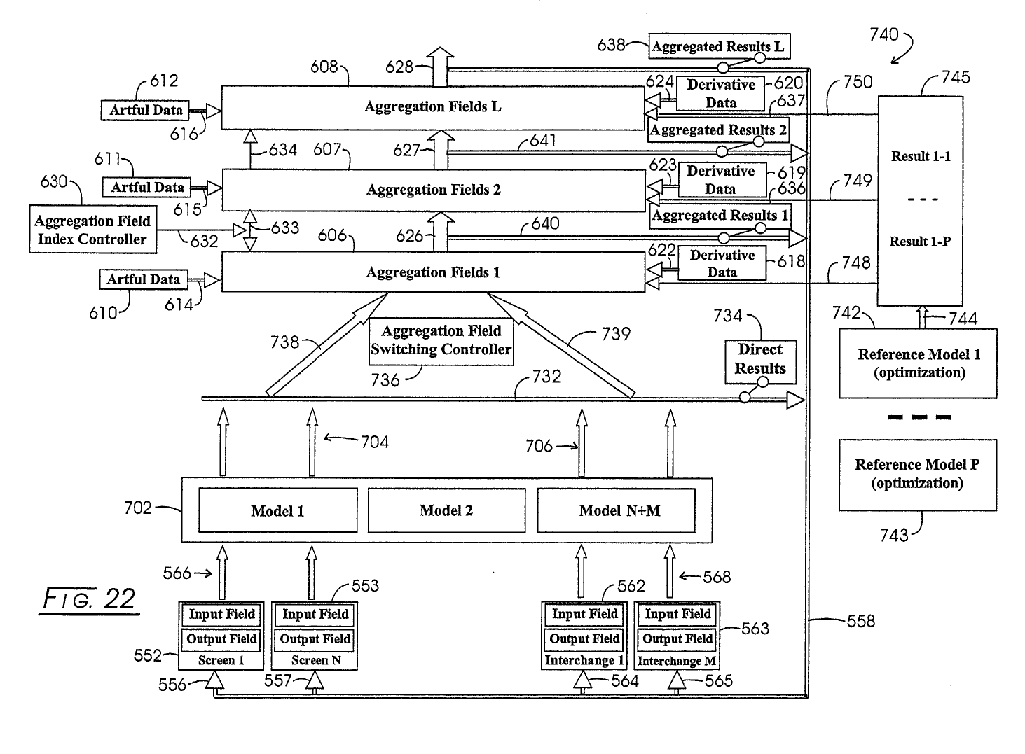

Referring to FIG. 22 a system is represented generally at 740 having an architecture very similar to system 730 described in conjunction with FIG. 21. Accordingly, components which are common between these systems are identified by the same numeration. System 740 has the flow through architecture of the system 730, however, system 740 provides for adaptive optimization through the media of reference models. Those reference models, identified as 1 through P, are represented at block 742743. The outputs of the reference models are provided as represented at arrow 744 and block 745. The latter results are fed to the aggregation fields shown at blocks 606-608 as represented by respective arrows 748-750.

As noted above- the reference models also can be employed in a feeding or enhancing relationship with the dedicated model components as identified at block 702. The various outputs of system 740 are directed via data conduit 558, for example, to both the interchange assemblies 562 and 563 as well as to the terminal assemblies as at 552 and 553. Terminals 552-553 may provide a readout, for example employing graphic software modules as above discussed.

Since certain changes may be made in the above system and method without departing from the scope of the invention herein involved, it is intended that all matter contained in the above-description or shown in the accompanying drawings shall be interpreted as illustrative and not in a limiting sense.

1. The method for determining an organization specific value of an information technology application in a system having computer-based infrastructure, user and computer support, as a consequence of an applied variation to that system comprising the steps of:
(a) deriving a base application value corresponding with the cost of an application use cost construct;
(b) deriving a business experience based coefficient for said cost construct derived in step (a), said coefficient representing the relative productivity contribution represented by said cost construct to said application;
(c) uplifting said base application value to provide an actual application value for said application by generating the product of the value of said cost construct and said business experience based coefficient;
(d) increasing said actual application value by the value of the highest optimized business value of a an enablement attribute construct of said application to provide a maximum business value of said application; and
(e) modifying maximum said business value of said application in correspondence with a derived operational cost of said application to derive the net business value of said application as said organization specific value.

2. The method of claim 1 in which said step (a) provides said application use cost construct as the cost of active concurrent users of the application.

3. The method of claim 1 in which said step (a) provides said application use cost construct as including the cost of said infrastructure corresponding with said application.

4. The method of claim 1 in which said step (a) provides said application use cost construct as including the cost of said support of the application use of said infrastructure.

5. The method of claim 2 in which said step (a) provides said application use cost as said cost of active concurrent users of the application for a single working day.

6. The method of claim 1 in which said step (d) determines said enablement attribute construct for said application as including the value of zero unavailability of said application.

7. The method of claim 1 in which said step (d) determines said enablement attribute construct for said application as including the value of perfect flexibility of the application to subsume said variation with zero latency.

8. The method of claim 1 in which said step (d) determines said enablement attribute construct for said application as including the value of perfect security of the application when it has subsumed said variation.

9. The method of claim I in which said step (d) of increasing said actual application value includes the step of:
(d1) determining an upper bound for said value of the highest optimized business value of an enablement attribute construct and providing that upper bound as said maximum business value of said application.

10. The method of claim 1 in which said step (e) includes the steps of:
(e1) reducing said value of the highest optimized business value of an enablement attribute construct of said application to a business value corresponding with a perceived business value of said enablement attribute construct, and combining said perceived business value with said actual application value to provide a potential business value; and
(e2) removing said operational cost of said application from said potential business value to derive said net business value.

11. The method of claim 1 in which said step (e) derives said operational cost of said application in correspondence with:
the desk top cost of computer hardware and software;
staff operational cost;
the effective cost of computer hardware and software storage; and
the effective cost of computer hardware and software servers.

12. The method of claim 11 in which said step (e) derives said operational cost of said application in correspondence with:
the effective cost of database software;
the effective cost of application software;
the effective cost of computer network hardware and software; and
the effective cost of services.

13. The method of claim 1 in which said step (d) derives said operational cost of said application in correspondence with line of business costs.

14. The method of claim 1 in which said step (e) derives said operational cost of said application in correspondence with information technology costs.

15. A system for determining an organization specific value of an information technology application in a computer based infrastructure, comprising:
a manual input terminal assembly having a perceptible readout and controllable to provide an input field for receiving treated derivative data and an output field for conveying artful data corresponding with attributes of said infrastructure;
a data interchange assembly controllable to provide an input field for receiving treated data and an output field for conveying treated attribute data corresponding with attributes of said infrastructure;
a memory retained model program controllable to respond to said artful data conveyed from said terminal assembly and to said treated attribute data for generating model derived treated derivative data;
at least one multi-cell aggregation field retained in memory, controllable to respond to said model derived treated derivative data, to said artful data and to said treated derivative data to provide said organization specific value; and
a controller configured for carrying out control of said terminal assembly, said data interchange assembly, said model program and control of said aggregation field to generate said organization specific value.

16. The system of claim 15 in which:
said memory retained model program comprises shared models;
including an input multiplexor controllable to distribute said artful data and said treated attribute data to said shared models; and
said controller is configured for carrying out indexing control of said multiplexor.

17. The system of claim 16 including:
buffer memory controllable to receive said model derived treated derivative data and transfer it to said aggregation field; and
said controller is configured for carrying out the control of said buffer memory.

18. The system of claim 15 including:
buffer memory controllable to receive said model derived treated derivative data and transfer it to said aggregation field; and
said controller is configured for carrying out the control of said buffer memory.

19. The system of claim 15 including a memory retained reference model program configured to optimize the performance of said aggregation field.

20. The system of claim 16 in which said input multiplexor includes an input queue for selectively retaining said artful data and said treated attribute data.

21. The system of claim 16 including a memory retained reference model program configured to optimize the performance of said aggregation field.

22. The system of claim 17 including a memory retained reference model program configured to optimize the performance of said aggregation field.

23. The system of claim 15 in which said memory retained model program comprises dedicated models.

24. The system of claim 23 including:
buffer memory controllable to receive said model derived treated derivative data and transfer it to said aggregation field; and
said controller is configured for carrying out the control of said buffer memory.

25. The system of claim 24 including a memory retained reference model program configured to optimize the performance of said aggregation field.

26. A system for determining an organization specific value of an information technology application in a computer based infrastructure, comprising:
a manual input terminal assembly having a perceptible readout, an input field for receiving treated data and an output field for conveying artful data corresponding with attributes of said infrastructure;
a data interchange assembly having an input field for receiving treated data on an output field for conveying treated attribute data corresponding with attributes of said infrastructure;
a memory retained dedicated model program responsive to said artful data conveyed from said terminal assembly and to said treated attribute data for generating model derived treated derivative data;
multi-cell aggregation fields with first and second hierarchal levels retained in temporary memory, controllable to respond to said model derived treated derivative data, to said artful data and to said treated derivation data to provide said organization specific value; and
a controller configured for carrying out switching control of said multi-cell aggregation fields.

27. The system of claim 26 including a memory retained reference model program configured to optimize the performance of said aggregation fields.

28. The system of claim 26 including:
buffer memory controllable to receive said model derived treated derivative data; and
said controller is configured for carrying out the control of said buffer memory.

29. The method for determining organization specific net business values of first through nth information technology applications in a system having a computer infrastructure, users and computer support, as a consequence of an applied variation to that system, comprising the steps of:
(a) deriving base application values corresponding with an application use cost construct for respective ones of said applications;
(b) deriving a business experience base factor for each said cost construct derived in step (a), each said factor representing the relative productivity contribution represented by a said cost construct to its corresponding application;
(c) uplifting said base application value for each of said applications by operating upon each with a said business experience based factor to provide actual application values for each said application;
(d) deriving a potential business value for each of said applications by operating upon each said actual application value with a value corresponding with a perceived value of an enablement attribute construct corresponding with said variation; and
(e) deriving a said net business value for each said application by deriving and removing the operational cost of the corresponding said application from a respective said potential business value.

30. The method of claim 29 including the step of:
(f) summing said net business values derived from said step (e) to provide a sum of net business values.

31. The method of claim 29 including the step of:
(g) summing the potential business values of said applications to provide a sum of potential business values.

32. The method of claim 29 including the step of:
(h) summing the actual application values of said applications to provide a sum of actual application values.

33. The method of claim 29 including the step of:
(i) summing the base application values of said applications to provide a sum of base application values.

34. The method of claim 29 including the step of:
(j) increasing said actual application value of each application by the value of the highest optimized business value of an enablement attribute construct corresponding with respective said applications to provide maximum business values for said applications.

35. The method of claim 34 including the step of:
(k) summing the maximum business values of said applications to provide a sum of maximum business values.

36. The method of claim 29 in which said step (e) derives said operational cost of each application in correspondence with its associated line of business costs;
and including the step of:
(I) summing the line of business costs of said applications to provide a sum of line of business costs.

37. The method of claim 29 in which:
said step (e) derives said operational cost of each application in correspondence with its associated information technology costs;
and including the step of:
(m) summing the information technology costs of said applications to provide a sum of information technology costs.

38. The method for determining an organization specific net business value of an information technology application with a system having a computer-based infrastructure, user and computer support, as a consequence of an applied variation to that system, comprising the steps of:
(a) deriving a base application value corresponding with an application use cost construct;
(b) deriving a business experience based factor for said cost construct derived in step (a), said factor corresponding with the relative productivity contribution represented by said cost construct to said application;
(c) uplifting said base application value for said application to provide an actual application value by operating upon it with said business experience based factor;
(d) deriving a potential business value for said application by operating upon said actual application value with a value representing a perceived value of an enablement attribute construct corresponding with said variation; and
(e) deriving said net business value of said information technology application by deriving and removing the operational cost of said application from said potential business value.

39. The method of claim 38 in which said step (a) derives said base application value as the loaded costs of active concurrent users of the application for a given time interval.

40. The method of claim 38 in which said step (d) determines said perceived value of an enablement attribute construct as including the value of availability of said application with respect to said applied variation.

41. The method of claim 38 in which said step (d) determines said perceived values of an enablement attribute construct as including the value of flexibility of said application with respect to said applied variation.

42. The method of claim 38 in which said step (d) determines said perceived value of enablement attribute contract as including the value of security of said application with respect to said applied variation.

43. The method of claim 38 in which said step (a) provides said application use cost construct as including the cost of said infrastructure corresponding with said application.

44. The method of claim 39 in which said step (a) provides said application use cost construct as including the cost of said support of the application use of said infrastructure.

45. The method of claim 39 in which said step (a) provides said application use cost as said cost of active concurrent users of the application for a single working day.

46. The method of claim 39 in which said step (d) derives said operational cost of said application in correspondence with line of business costs.

47. The method of claim 39 in which said step (e) derives said operational cost of said application in correspondence with information technology costs.

48. The method of claim 39 in which said step (e) derives said operational cost of said application in correspondence with:
the desk top cost of computer hardware and software;
staff operational cost;
the effective cost of computer hardware and software storage; and
the effective cost of computer hardware and software servers.

49. The method of claim 39 in which said step (e) derives said operational cost of said application in correspondence with:
the effective cost of database software;
the effective cost of application software;
the effective cost of computer network hardware and software; and
the effective cost of services.
